(19) United States
(12) Patent Application Publication
(10) Pub. No.: US 2024/0092036 A1
(43) Pub. Date: Mar. 21, 2024

(54) Rotating-Base Multi-Articulable Machine for Fusing Polyolefin Pipe

(71) Applicant: McElroy Manufacturing, Inc., Tulsa, OK (US)

(72) Inventors: Arthur H. McElroy, II, Tulsa, OK (US); Paul John Donaldson, Broken Arrow, OK (US); Eric R. Abbott, Morris, OK (US); Seth P. Ahrens, Tulsa, OK (US); Douglas K. Brownell, Tulsa, OK (US); Gregory A. Ruoff, Broken Arrow, OK (US); Jared D. Sparks, Tulsa, OK (US); Matthew A. Price, Broken Arrow, OK (US)

(21) Appl. No.: 18/370,867

(22) Filed: Sep. 20, 2023

Related U.S. Application Data
(60) Provisional application No. 63/408,837, filed on Sep. 21, 2022.

(51) Int. Cl. B29C 65/00

(52) U.S. Cl. CPC B29C 66/834; B29C 66/522; B29C 66/87

(57) ABSTRACT

A pipe fusion machine including a track mounted chassis supporting a horizontal turntable for unlimited, reversible rotation relative to the chassis. A boom pivotally attached at a rear end of, and extending forwardly of, the turntable enables manipulation of elevations and distances of the free end of the boom. The free end of the boom is adapted to permit pivotal mounting thereon of a pipe fusion tool such as an indexer configured to articulate and support a pipe-end facer and a pipe-end heater for respective independent orientation into and out of alignment with the ends of pipes to be fused. A carriage supports fixed and sliding jaws adapted to grip the ends of pipes to be fused for relative reciprocal movement during a pipe fusion process. Each of the jaws may include an upper half jaw and lower left and right quarter jaws.

### CROSS-REFERENCE TO RELATED CASES

This application claims the benefit of U.S. provisional patent application Ser. No. 63/408,837, filed on Sep. 21, 2022, and incorporates such provisional application by reference into this disclosure as if fully set out at this point.

### BACKGROUND OF THE INVENTION

This invention relates generally to portable machines for fusing polyolefin pipe and more particularly concerns a self-contained and self-propelled machine and method for the end-to-end treatment of two axially aligned pipe ends for the purpose of heat fusing such pipes together.

The principle of heat fusion is to heat two surfaces to a designated temperature and then fuse them together by application of force. The pressure causes flow of the melted materials, which causes mixing and thus fusion. When a polyolefin pipe is heated, the molecular structure is transformed from a crystalline state into an amorphous condition. When fusion pressure is applied, the molecules from each pipe end mix. As the joint cools, the molecules return to their crystalline form, the original interfaces are gone, and the two pipes have become one homogeneous pipe. The joint area becomes stronger than the pipe itself in both tensile and pressure conditions.

The principle operations of this fusion process include clamping the pipe pieces axially to allow all subsequent operations to take place, facing the pipe ends to establish clean parallel mating surfaces perpendicular to the centerline of the pipes, aligning the pipe ends with each other to minimize mismatch or high-low of the pipe walls, heating at a first specified force in a melt pattern that penetrates into the pipe around both pipe ends, joining the melt patterns with a second specified force which must be constant around the interface area and holding the molten joint immobile with a third specified force until adequately cooled.

Historically, portable pipe fusion machines were typically four wheeled cart type machines such as described in U.S. Pat. Nos. 3,729,360; 4,352,708 and 5,013,376. While these machines perform quite well, they require a good deal of labor and additional expensive equipment such as cranes, forklifts, tractors, trucks and the like to load, unload and precisely position the machine on the pipeline. Many machines are damaged during the loading and unloading process. Furthermore, the operators experience stress and fatigue in maneuvering the machines over difficult terrain and conditions.

A big step forward in addressing the above issues is embodied in U.S. Pat. No. 5,814,182 “Self-Contained and Self-Propelled Machine for Heat Fusing Polyolefin Pipes” to McElroy and assigned to McElroy Manufacturing, Inc. The '182 patent relates to a machine, and a method using the machine, for fusing polyolefin pipes wherein the machine is fully self-contained, requires no additional equipment to support operation of the machine, and has transport tracks aligned for movement along an axis parallel to the axial pipe alignment within the machine jaws, wherein pipe is received within upwardly facing jaws located on the machine. The '182 patent further relates to a fully self-propelled machine for forward or reverse movement, left or right movement and pivotal movement about its center, is movable along the pipeline from a completed joint to the next joint location, and has a tracked undercarriage to increase mobility, stability and maneuverability.

U.S. Pat. No. 10,369,751 for, “Top-Loading Straddle-Mounted Pipe Fusion Machine” to Lawrence et al. and assigned to McElroy Manufacturing, Inc. relates to a fusion machine that can be top-loaded on very large pipes and pipelines, i.e., by positioning downwardly facing clamps above the pipe or pipeline. The pipe fusion machine is self-propelled on tracks that straddle the pipe. The top-loading machine minimizes the need for heavy equipment to load and unload pipe to and from the fusion machine.

It is, therefore, an object of the invention to provide a self-propelled, self-contained, rotating-base, multi-articulable machine for butt fusion of polyolefin pipe. It is also an object of the invention to provide a boom, an indexer, a carriage and carriage jaws that are co-operable to achieve such a machine.

### SUMMARY OF THE INVENTION

In accordance with the invention, a pipe fusion machine has a track mounted chassis supporting a horizontal turntable for reversible rotation relative to the chassis. A boom pivotally attached at a rear end of, and extending forwardly of, the front of the turntable and beyond a footprint of the tracks is configured to enable manipulation of elevations and distances of the free end of the boom in relation to the rear end of the pivotal attachment. The free end of the boom is adapted to permit pivotal mounting thereon of a pipe fusion tool. Preferably, the range of reversible rotation of the horizontal turntable is unlimited.

The pipe fusion tool may be an indexer configured to articulate on a free end of the boom and to support a pipe-end facer and a pipe-end heater for respective independent orientation into and out of alignment with the ends of pipes to be fused.

The pipe fusion machine may also have a carriage rigidly connected to, but removable from, the indexer for articulation in unison therewith. The carriage supports fixed and sliding jaws adapted to grip the ends of pipes to be fused for relative reciprocal movement of one end of a pipe toward and away from an end of a pipeline during a pipe fusion process.

Each of the jaws may include an upper half jaw with a semi-cylindrical inner surface, lower left and right quarter jaws each with an inner surface of radius equal to the radius of the semi-cylindrical inner surface, and left and right links. Each link is pivotally engaged at its upper end to a corresponding lower portion of the upper half jaw and is pivotally engageable at its lower end with a corresponding quarter jaw. Thus, as the pipe is being gripped, the upper jaw inner surface and the corresponding lower quarter jaw inner surfaces cooperate to conform to the outer surface of a pipe having an outer surface of radius equal to the half jaw radius. Each of the jaws may also have an actuator co-operable with a respective link for selectively manipulating the quarter jaw between open and closed positions.

Each of the jaws may further have an upper half jaw insert. The outer radius of the insert is equal to the radius of the semi-cylindrical inner surface of the upper half jaw. The inner radius of the insert is less than the inner radius of the semi-cylindrical inner surface of the upper half jaw. Replacement lower left and right quarter jaws each have an inner surface of radius equal to the inner radius of the upper half jaw insert. Thus, the inner surface of the upper jaw insert and the inner surfaces of the corresponding lower quarter jaw replacements cooperate to conform to the outer surface of a pipe having an outer surface of radius less than the radius of the pipe being gripped.

The machine for fusing polyolefin pipe may also include a heater adapted for fusing two opposing ends of polyolefin pipe; a hydraulic generator motor adapted to actuate a generator; a supply of hydraulic fluid; a hydraulic pump adapted to receive the supply of hydraulic fluid at a first flow and distribute the supply of hydraulic fluid at a second flow; a generator valve adapted to receive the hydraulic fluid at the second flow and meter the fluid at a hydraulic fluid flow sufficient to run the hydraulic generator motor at a constant desired speed; and, a generator adapted to be actuated by the hydraulic generator motor in order to produce sufficient electric energy to maintain the heater at least at a temperature sufficient to fuse two opposing ends of polyolefin pipe. The motor, hydraulic pump, generator valve, hydraulic generator motor, and generator may be mounted to the machine turntable.

The machine motor powers a power take off (PTO) such that the hydraulic pump is driven by the PTO of the machine motor. The hydraulic pump may be mounted to the PTO of the motor. The motor may be adapted to run at variable speeds and the hydraulic generator motor adapted to run at a constant desired speed to actuate the generator in order to produce sufficient electric energy to maintain the heater at least at a temperature sufficient to fuse the two opposing ends of the polyolefin pipe regardless of the speed of the motor. The generator is preferably in direct electrical communication with the heater.

In one embodiment, the pipe fusion machine includes a horizontal chassis mounted on independently reversible drive tracks. The chassis is symmetrical with respect to an X-Z plane centered between the tracks. A horizontal platform is mounted above the chassis for reversible rotation about a Y-axis of the X-Z plane. A boom has left and right mirrored parallel linkages on opposite sides of and equidistant from the Y-axis. Rear portions of the linkages are pivotally mounted on the platform for rotation on a first common X-axis rearward of the Y-axis. The left and right linkages are configured for simultaneous adjustment of the elevations and distances of their free ends with the free ends aligned on a second common X-axis forward of the Y-axis and extending beyond a footprint of the tracks and chassis. In this embodiment, each linkage has an articulator and a knuckle with an extender therebetween. The articulator is pivotally mounted on the platform. The extender is mounted for reciprocal longitudinal motion relative to the forward portion of the articulator. The knuckle is pivotally mounted on a free end of the extender.

Also in accordance with the invention, a boom is provided that enables manipulation of a pipe fusion machine tool from a horizontal platform of the machine. One embodiment of the boom includes left and right parallel linkages mirrored on opposite sides of and equidistant from a Y-axis through the platform. Rear portions of the linkages are pivotally mountable on the platform for rotation on a first common X-axis rearward of the Y-axis. The left and right linkages are configured for simultaneous adjustment of the elevations and distances of the free ends of the left and right linkages with the free ends aligned on a second common X-axis forward of the machine. In this embodiment of the boom, each linkage also includes an articulator and a knuckle with an extender therebetween. The articulator is pivotally mounted on the platform. The extender is mounted for reciprocal longitudinal motion relative to a forward portion of the articulator. The knuckle is pivotally mounted on a free end of the extender.

Also in accordance with the invention, an indexer is provided that enables detachable connection of a carriage to the boom of a pipe fusion machine. One embodiment of the indexer includes rear adapters configured for removable connection of the indexer on a free end of the boom. The adapters permit articulation of the indexer on the free end of the boom about a horizontal axis extending perpendicular to the boom. A center support rod extends transversely across the indexer forward of the rear adapters and between end plates of the indexer. An upper indexer rod extends between the end plates and parallel to the center support rod. A lower indexer rod extends inwardly from one of the end plates and parallel to the center support rod. A pipe end facer and a pipe heater hang from the upper indexer rod for independent rotation in spaced-apart parallel planes. Front adapters are configured for removable rigid connection of the carriage to the indexer.

For this embodiment of the indexer, a carriage is provided that has rear adapters configured for removable rigid connection of the carriage to the indexer for articulation of the fusion carriage assembly in unison with the indexer assembly. Parallel horizontal spaced-apart guide rails extend across the front of the rear adapters. At least one jaw fixed on one end of the horizontal spaced-apart guide rails is adapted to grip an end of a first pipe to be fused. At least one other jaw slidable on another end of the horizontal spaced-apart guide rails is adapted to grip an end of a second pipe to be fused to the first pipe. The at least one other jaw is driven for relative reciprocal movement of the gripped end of the second pipe toward and away from the gripped end of the first pipe during a pipe fusion process.

In this embodiment of the carriage, the horizontal locations of the pipe end facer and the pipe end heater are independently alignable during the relative reciprocal movement of the gripped end of the second pipe. The aligned facer or pipe is rotated into alignment between the pipes gripped by the at least one jaw and the at least one other jaw.

Also in accordance with the invention, a jaw for gripping a pipe is provided. The jaw has an upper half jaw with a semi-cylindrical inner surface. Lower left and right quarter jaws each have an inner surface of radius equal to the radius of the semi-cylindrical inner surface of the half jaw. Left and right links are each pivotally engaged at their upper end to a corresponding lower portion of the upper half jaw. Each link is also pivotally engageable at its lower end with a corresponding quarter jaw. Thus, the inner surface of the upper jaw and the corresponding inner surfaces of the lower quarter jaws cooperate as the pipe is being gripped to conform to the outer surface of the pipe.

Preferably, each of the jaws also has an actuator co-operable with a respective link for selectively manipulating the quarter jaw between open and closed positions.

In one embodiment, a jaw includes an upper half jaw insert with an outer radius equal to the radius of the semi-cylindrical inner surface and an inner radius less than the inner radius of the semi-cylindrical inner surface. Lower left and right replacement quarter jaws have inner surfaces of radius equal to the inner radius of the upper half jaw insert. Thus, the inner surface of the upper jaw insert and the inner surfaces of corresponding replacement quarter jaws cooperate to conform to the outer surface of the pipe.

The present disclosure may also include a method to provide constant electrical energy from a hydraulic generator to maintain a polyolefin pipe fusion heater at least at a temperature sufficient to fuse two opposing ends of polyolefin pipe from a hydraulic system on a machine having multiple hydraulic systems powered by a single engine having an output and a PTO. The method may include the following steps: providing a supply of hydraulic fluid; mounting a hydraulic pump to the PTO of the engine; adapting the hydraulic pump to receive the supply of hydraulic fluid at a first flow and distribute the supply of hydraulic fluid at a second flow; adapting a generator valve to receive the hydraulic fluid at the second flow and meter the fluid at a hydraulic fluid flow sufficient to run the hydraulic generator motor at a constant desired speed; mounting the hydraulic generator motor to a generator; adapting the generator to be actuated by the hydraulic generator motor; and, actuating the generator in order to produce sufficient electric energy to maintain the heater at least at a temperature sufficient to fuse two opposing ends of polyolefin pipe.

### BRIEF DESCRIPTION OF THE DRAWINGS

Other objects and advantages of the invention will become apparent upon reading the following detailed description and upon reference to the drawings in which:

FIG. 1 is a perspective view of the machine of the present disclosure;

FIG. 2 is a rotated perspective view of the machine of FIG. 1 depicted engaging a section of polyolefin pipe;

FIG. 3 is the perspective view of FIG. 2 without a section of pipe;

FIG. 4 is a perspective view of the chassis of the machine of the present disclosure;

FIG. 5 is a partial cut-away view of the tracks, chassis and turntable of the machine of the present disclosure;

FIG. 6 is a plan view depicting a general layout of the components positioned on the platform of the machine of the present disclosure;

FIG. 7 is a detailed view of the layout of FIG. 5;

FIG. 8 is a perspective view of the layout of FIG. 6;

FIG. 9 is the perspective view of FIG. 8 depicted with the cowling installed;

FIG. 10A is a perspective view of the linkages with partial cut-aways;

FIG. 10B is the view of FIG. 10A without partial cut-aways;

FIG. 11 is a perspective view of an indexer and a carriage in a disconnected condition;

FIG. 12 is a front perspective view of the indexer and carriage of FIG. 11 shown in a connected condition;

FIG. 13 is a rear perspective view of the indexer and carriage of FIG. 11 in a connected condition;

FIG. 14 is a rear perspective view of the carriage of FIG. 11;

FIG. 15 is a rear perspective view of the carriage of FIG. 11 with a rear cover removed;

FIG. 16 is a left elevation view of the carriage of FIG. 11 showing a fixed jaw of the carriage gripping a pipe;

FIG. 17 is a left elevation view of the carriage of FIG. 11 showing the fixed jaw of FIG. 16 adapted for gripping a smaller diameter pipe;

FIG. 18 is a block diagram of the hydraulic system of the machine of the present disclosure;

FIG. 19 is block diagram of the hydraulic generator system of the present disclosure;

FIG. 20 is a block diagram depicting the electrical system of the machine of the present disclosure;

FIG. 21 depicts the remote used to operate the machine of the present disclosure;

FIG. 22 depicts the remote of FIG. 21 detailing the Tracks and Boom/Swing/Extend screens;

FIG. 23A depicts the remote of FIG. 21 wherein the Jaws and Carriage screens are depicted;

FIG. 23B depicts the remote of FIG. 21 wherein the Indexing and Carriage screens are depicted

FIG. 24A is an elevation view of the machine of the invention with the boom in a neutral and retracted position;

FIG. 24B is an elevation view of the machine of the invention with the boom in a neutral and extended position;

FIG. 24C is an elevation view of the machine of the invention with the boom in a lowered and retracted position;

FIG. 24D is an elevation view of the machine of the invention with the boom in a lowered and extended position;

FIG. 24E is an elevation view of the machine of the invention with the boom in a raised and retracted position;

FIG. 24F is an elevation view of the machine of the invention with the boom in a raised and extended position;

FIGS. 24A′-FIG. 24F′ are FIGS. 24A-24F with the carriage attached to the indexer;

FIG. 25A is an elevation view of the machine of the invention with the boom in a neutral and extended position with the turntable and boom parallel with the tracks;

FIG. 25B is an elevation view of the machine of the invention with the boom in a neutral and extended position with the turntable and boom perpendicular to the tracks;

FIG. 26 is a plan view of the machine of the invention showing the turntable assembly slewed or swung 90 degrees with respect to the tracks for facilitating fusing operation on the pipe while enabling movement of the machine in a direction parallel to the pipes; and

FIG. 27 is a rear elevation view of the machine of the invention showing a manual control center for manual operation of the machine.

While the invention will be described in connection with preferred embodiments thereof, it will be understood that it is not intended to limit the invention to those embodiments or to the details of the construction or arrangement of parts illustrated in the accompanying drawings.

### DETAILED DESCRIPTION

### Machine Overview

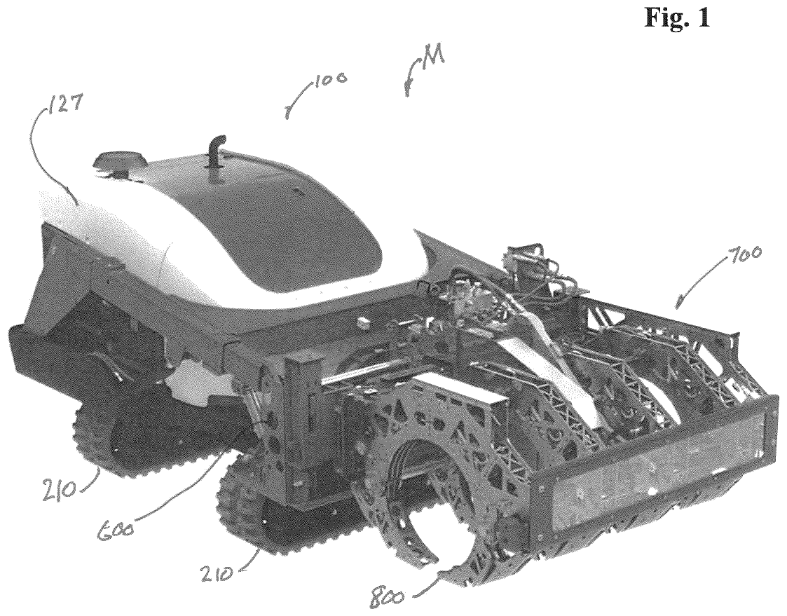

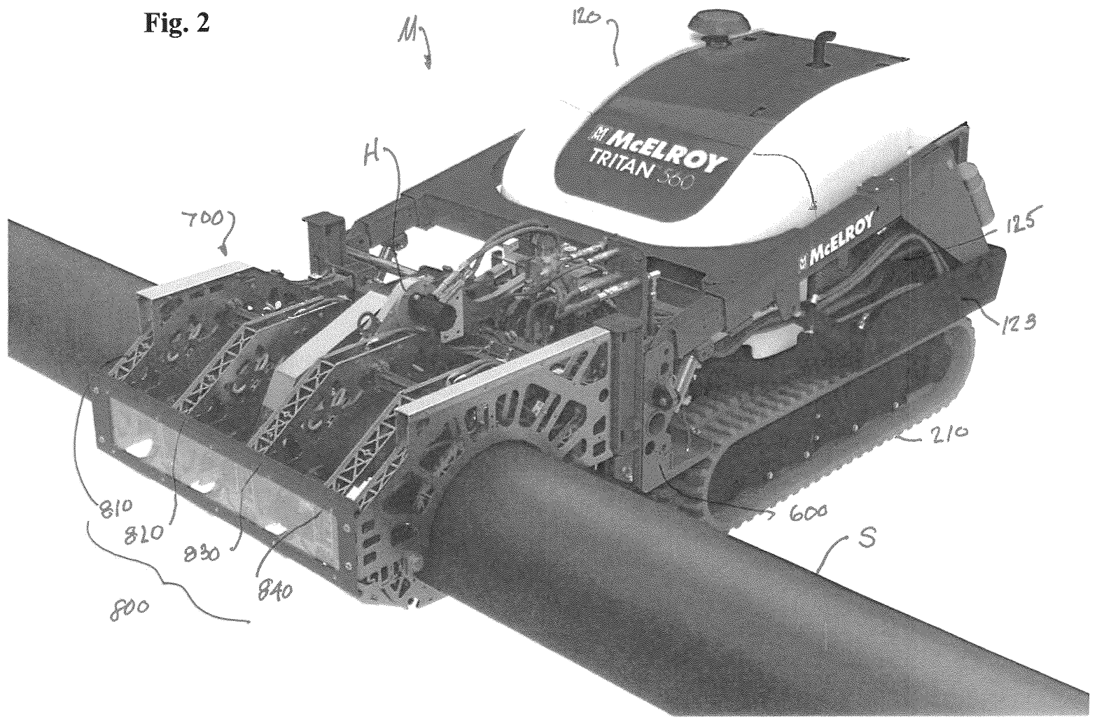

Looking first at FIGS. 1-3, a preferred embodiment of a self-contained and self-propelled machine M grips, aligns, faces, heats and fuses one end of a medium diameter polyolefin pipe stick S to the free end of a polyolefin pipeline L of the same diameter. “Polyolefin” identifies a most common application of a fusion machine but, as used herein, is intended to include “nylon,” PVC and other fusible non-polyolefin pipes. As herein used, “medium diameter” refers to pipes ranging generally from 2 to 22 inches in diameter. In FIG. 2, the machine M is shown gripping a 20 inch diameter polyolefin pipe stick S.

Looking now at FIGS. 1-5, the machine M has a housing 100 including a horizontal platform 110 and a cowling 120. The cowling 120 covers the platform 110 from front to rear. The platform 110 has left and right wings 121 outside of the cowling 120. The outer edges of the wings 121 have upright flanges 123 and parallel brackets 125 extending up from the platform 110 adjacent the side walls 127 of the cowling 120 to form side channels 129 in the wings 121.

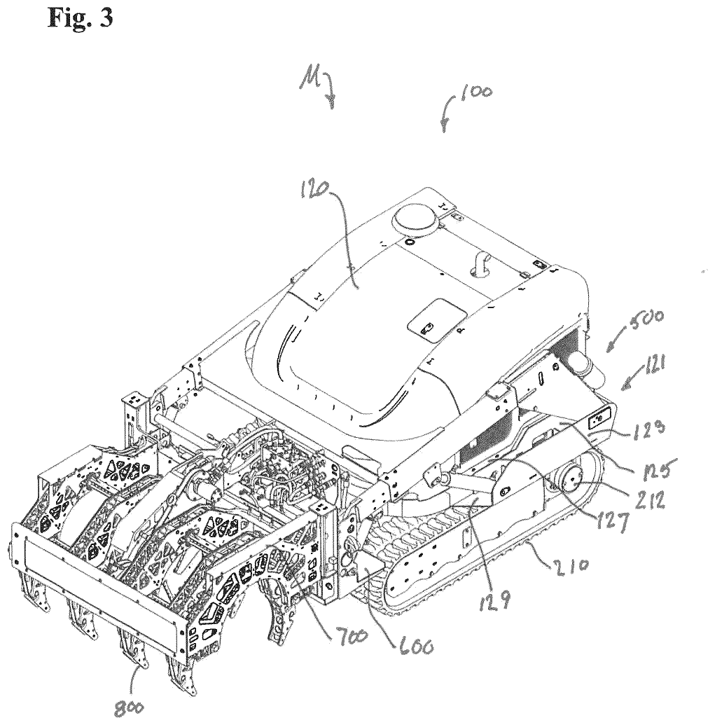

Turning to FIGS. 3-5, a chassis 200, riding on parallel left and right tracks 210 driven by independently reversible hydraulic track motors 212, supports a turntable 300. The turntable 300 includes a swing drive 315 centered on an hydraulic union 317. The base 319 of the turntable 300 is reversibly driven by an hydraulic screw motor 321.

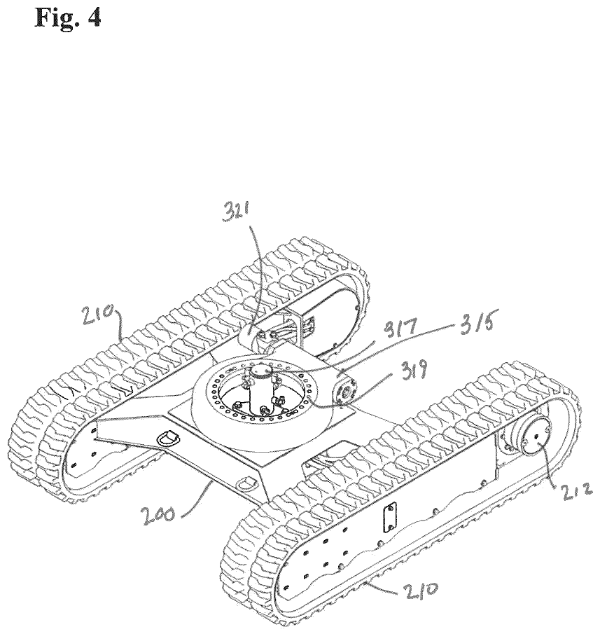

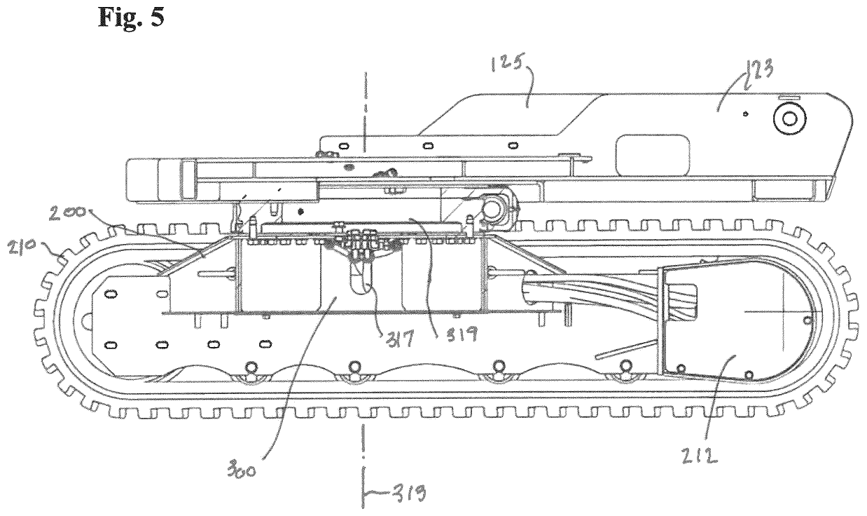

Turning to FIGS. 4 and 5, a chassis 200, riding on parallel left and right tracks 210 driven by independently reversible hydraulic track motors 212, supports a turntable 300. The turntable 300 includes a swing drive 315 centered on an hydraulic union 317. The base 319 of the turntable 300 is reversibly driven by an hydraulic screw motor 321.

The base 319 supports the housing platform 110 above the tracks 210 and the chassis 200, so the platform 110 is free to rotate on demand in endless clockwise 311 and counterclockwise wise 312 directions about a vertical axis 313 centered between the tracks 210.

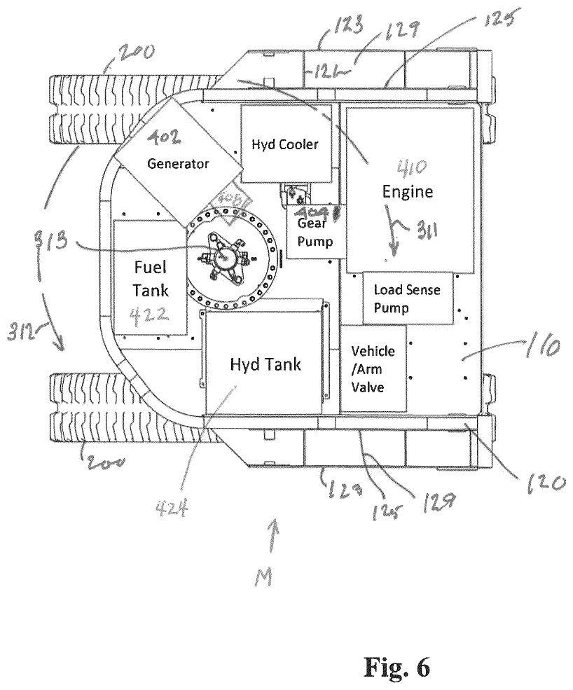

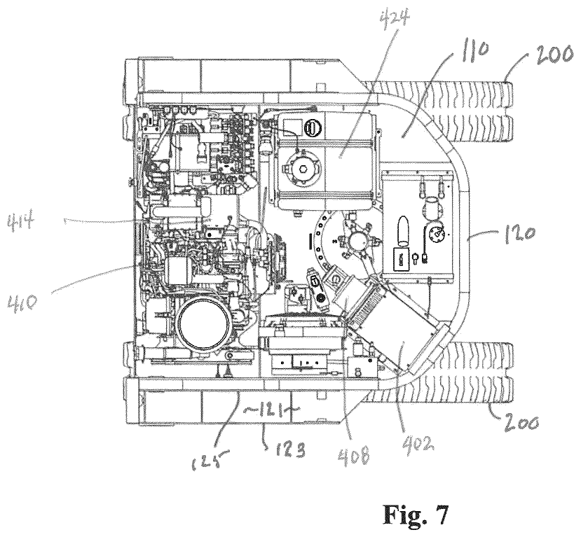

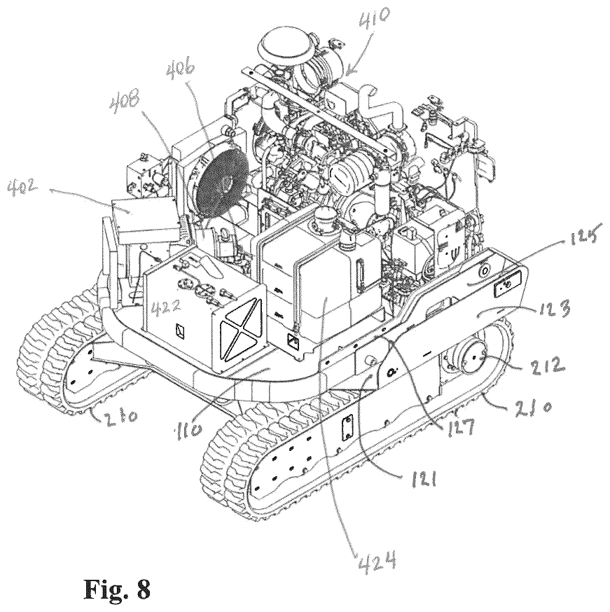

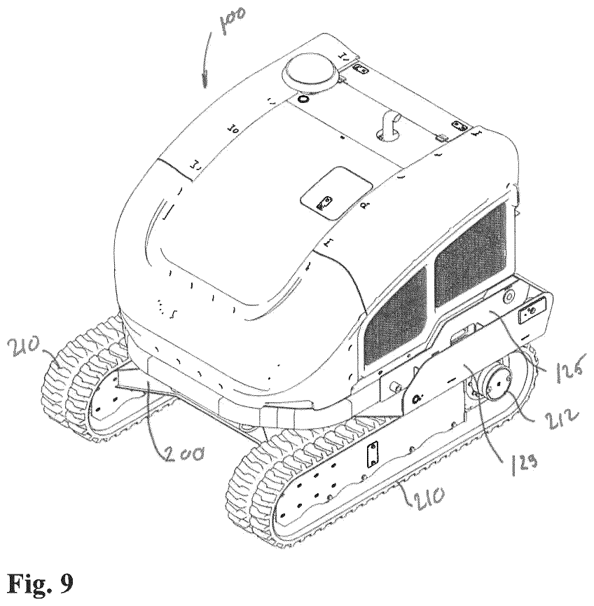

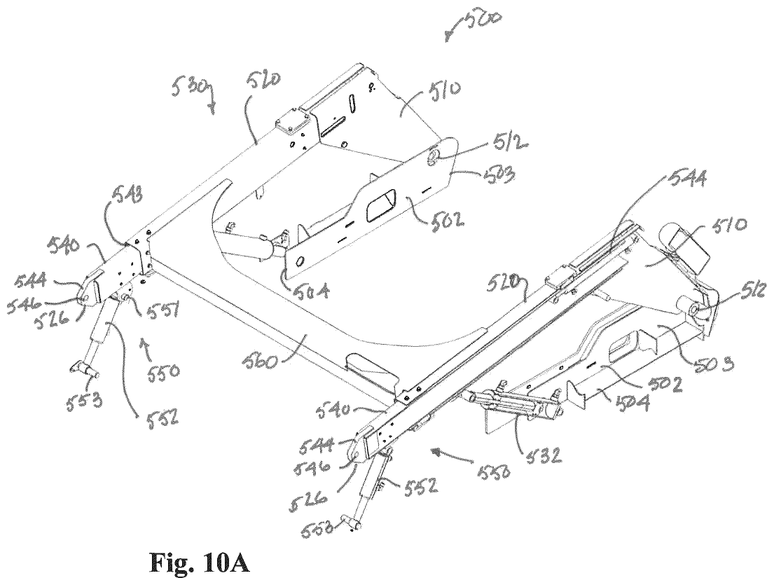

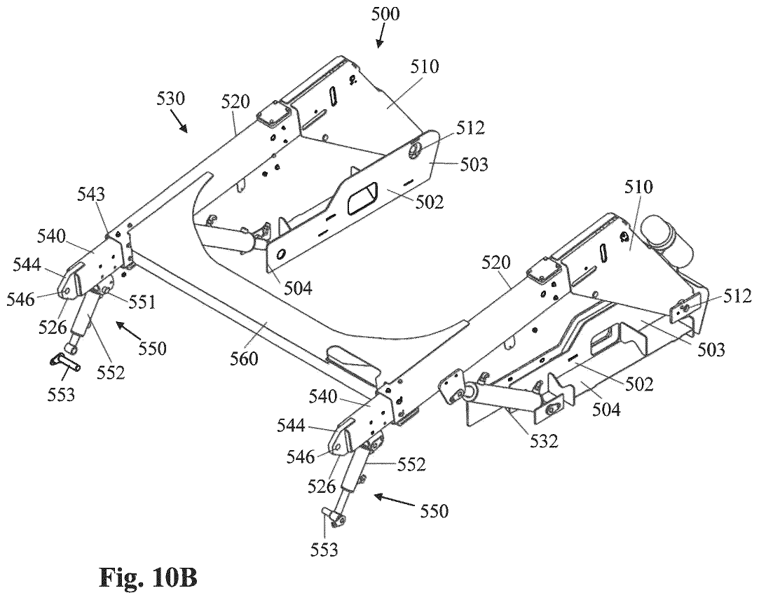

Moving on to FIGS. 6-11, various hydraulic and electrical systems and assemblies mounted on the platform 110 inside of the cowling 120 operate the various job-related systems and assemblies mounted on the wings 121 of the platform 110 outside of the cowling 120.

As best seen in FIGS. 6-8, the major components mounted on the platform 110 inside of the cowling 120 include the hydraulic generator system 400 in the front right corner of the cowling 120, the engine 410 with its gear pump 412 and load sense pump 414 in the back right corner of the cowling 120, the hydraulic cooler 416 on the right side of the cowling 120 between the generator 420 and the engine 410, the engine fuel tank 422 at the front of the cowling 120, the hydraulic fluid tank 424 on the left side of the cowling 120 opposite the hydraulic cooler 416 and the vehicle/arm valve 426 on the left side of the cowling 122 to the rear of the hydraulic fluid tank 424. The above footprint was at least in part selected in consideration of the overall balance of the machine M in loaded and unloaded conditions.

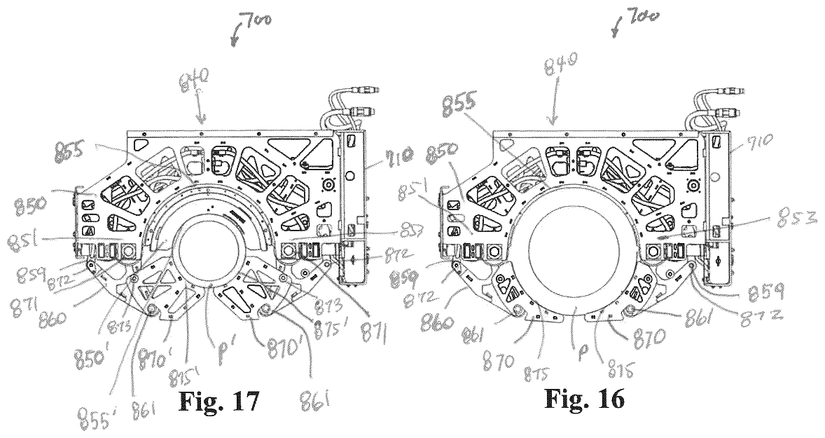

As best seen in FIGS. 1-3, outside of the cowling the machine M has a boom B in the form of parallel and mirrored left and right linkages 500. Looking at FIGS. 16A and 16B, each linkage 500 has a dogleg shaped arm, a straight arm telescoping from the long end of the dogleg shaped arm and a knuckle at the end of the telescoping arm. The short end of the dogleg shaped arm is pinned for vertical plane rotation at the rear end of its corresponding channel A first cylinder connected between the long portion of the dogleg shaped arm and the front end of its corresponding channel rotates to raise and lower the long end of the arm in the vertical plane. A second cylinder inside of the long portion of the dogleg shaped arm pulls and pushes the telescoping arm out of and into the long portion of the dogleg. A third cylinder is pinned to knuckle in the vertical plane under the end of the telescoping arm.

As best seen in FIGS. 17-21, outside of the cowling the machine M also has an indexer 600 and a carriage 700 adapted for rigid front-to-back connection to each other, respectively. The combined indexer 600 and carriage 700 span the perpendicular distance between the linkages 500 and the ends of the indexer assembly are adapted to pivot at the otherwise free ends of the corresponding telescoping arms in response to the operation of the third cylinder under the end of the telescoping arm. Thus, the combined indexer and carriage assemblies 600 and 700 are able to be rotated clockwise and counterclockwise about a horizontal axis extending between the ends of the telescoping arms.

A pipe facer F and a pipe heater H of diameter suited to pipe to be fused hang from a horizontal guide rod extending across the indexer assembly 600 for rotation in parallel planes perpendicular to the guide rod. Spaced apart fixed and sliding jaws suited to grip the pipeline and the pipe to be fused, respectively, are mounted on parallel horizontal guide rails on the carriage assembly 700. The space between the fixed and sliding jaws is selectively opened and closed under the control of the fusion machine programs, opening to receive the facer F, closing to face the pipe ends, opening to release the facer F and receive the heater H, closing to melt the opposing pipe ends, opening to release the heater H, closing to fuse the pipe to the pipeline and then opening to release the fused pipe and pipeline.

The track and chassis assembly 200 enables the machine M to approach the point of fusion from any direction. Once the machine M is positioned with the jaws 800 generally over the point of fusion, the operator can selectively, for any number of times and in any order, operate the track drive motors 212, the slew drive motor 214 and the first, second and third cylinders of the linkages 500 to precisely orient the jaws 800 in relation to the point of fusion for performance of the computer controlled fusion process.

### Hydraulic Generator System

With reference to FIGS. 6-8, and 18-20, the generator hydraulic system 400 of machine M shall next be described. Hydraulic generator system 400 transforms hydraulic power developed and provided by machine M into high-quality electricity with great efficiency. Reliable start and efficient operation, as well as the elimination of the need to carry additional fuel on machine M, are benefits provided by hydraulic generator system 400. Other benefits include long-running life and durability. Most importantly, however, is the constant output of quality electricity to fusion heater H. Hydraulic generator system 400, operating with power derived from the PTO of the engine 410 of machine M is operated separate and apart from the hydraulic systems associated with the load sense pump 414 which operates directly from the output of engine/motor 410 of machine M. In other words, hydraulic pump 404 is continually providing hydraulic flow to hydraulic generator valve 406 (FIG. 19) regardless of the demands of other hydraulic systems on machine M which might otherwise rob and deprive hydraulic flow to hydraulic valve 406 sufficient to run hydraulic generator motor 408 at a constant speed. This separately operated system thereby guarantees high-quality electricity is always available to fusion heater H from hydraulic generator system 400.

Hydraulic generator system 400 is selected and designed to provide consistent power sufficient to maintain fusion heater H at the proper temperature for fusion, regardless of the speed of the machine M engine/motor. The electricity generated by generator hydraulic system 400 is suitable for consumption by fusion heater H in the pipe fusion process by converting that electrical energy into heat energy sufficient for pipe fusion. Typical heaters suitable for the purposes of this invention are described in greater detail in U.S. Pat. No. 3,846,208 entitled “Combination Pipe Fusion Unit” and U.S. Pat. No. 4,227,067 entitled “Heater Adapter for Making Polyethylene Pipe Connections”, incorporated fully herein by reference.

Generator hydraulic system 400 includes, in a basic embodiment: a hydraulic pump 404, a supply of hydraulic oil/fluid 424, a generator valve (hydraulic valve) 406; a generator hydraulic motor 408; and a generator 402. In a preferred arrangement, hydraulic motor 408 is mounted onto generator 410 which may be referred together herein as generator 402 or hydraulic generator 402.

Hydraulic pump 404 in a preferred embodiment may be a hydraulic gear pump, however, it will be understood by one of skill in the art that other types of hydraulic pumps could be substituted and all such pumps are considered “hydraulic pumps 404” as that term is used herein. Hydraulic pump 404 converts mechanical power derived from the machine M engine/motor (via its PTO) into hydraulic energy. This hydraulic energy of the hydraulic fluid created by hydraulic pump 404 is transferred (by the hydraulic pump 404) to generator valve 404 through suitable hydraulic fluid lines.

In the hydraulic (gear) pump 404 of the preferred embodiment, rotation of gears within hydraulic (gear) pump 404 is achieved using that mechanical power from the PTO. This causes suction at an inlet of hydraulic pump 404 such that hydraulic fluid is drawn from hydraulic tank/reservoir 424 through suitable hydraulic lines into hydraulic pump 404. Hydraulic fluid then flows over gears. The mechanical energy derived from the rotation of the gears is thus transferred into increased hydraulic fluid flow (or pressure) at the discharge of hydraulic pump 404 and directed to generator/hydraulic valve 406.

A supply of hydraulic fluid is provided from hydraulic fluid tank/reservoir 424 which is plumbed through hydraulic lines (not shown but well known in the art) to be in fluid communication with hydraulic pump 404, generator valve 406, and generator hydraulic motor 408. Hydraulic pump 404 is driven from the power take off (PTO) of engine/motor mounted on machine M. In the preferred embodiment the rotational speed (rpm) of the PTO operates at about 10-15% higher than the speed of the engine of machine M at any given time.

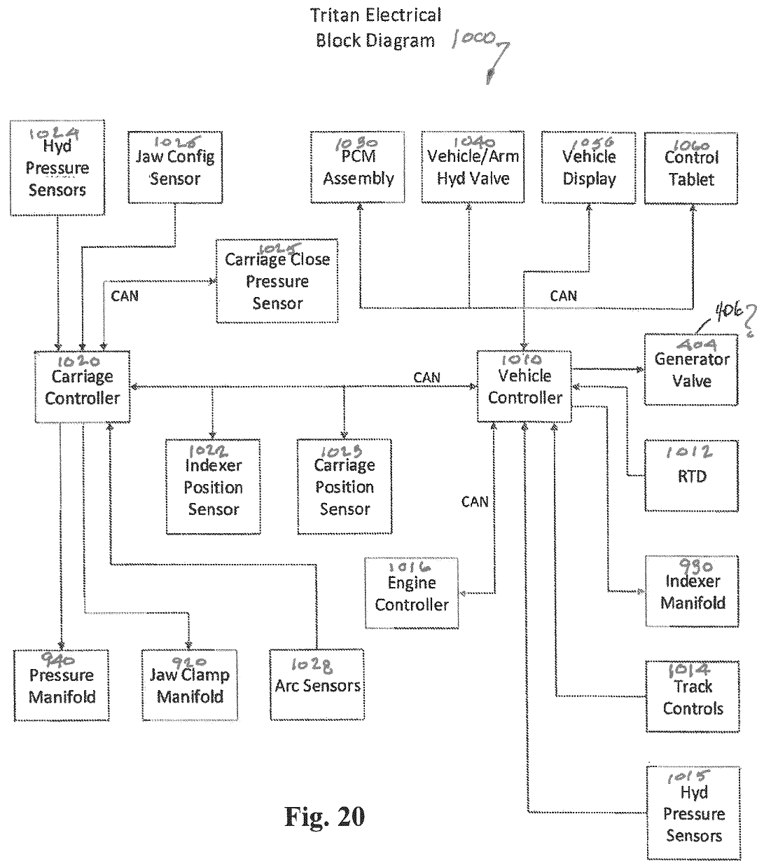

Hydraulic pump 404 receives a supply of hydraulic fluid from reservoir 424 at a first flow (or pressure) and distributes a supply of that hydraulic fluid at a second (higher) flow (or pressure). Since the speed of the PTO varies with variations in the speed of engine 410 (which may be dictated by the demands of other hydraulic systems) the second flow rate (or hydraulic fluid pressure) will vary. Generator/hydraulic valve 406 is in hydraulic fluid communication via hydraulic lines (not shown) with hydraulic pump 404 and adapted to receive hydraulic fluid at the second flow (or pressure). Hydraulic valve 406 then meters that hydraulic fluid flow to generator motor 408 at a flow (or pressure) sufficient to run hydraulic generator motor 408 at a constant desired speed. This is regardless of the second flow rate which may vary due to variations in PTO/hydraulic pump 404's speed. As depicted in FIG. 20, the electrical diagram, generator valve 406 is in electrical communication with a vehicle controller/processor (which, in turn, is in electrical communication with an engine controller/processor). Information/instructions exchanged between the engine controller/processor of machine M and the vehicle controller/processor ensures generator hydraulic valve 406 maintains the proper flow of hydraulic fluid through generator hydraulic valve 406 to run hydraulic generator motor 408 at the constant speed sufficient for generator 402 to supply sufficient electric energy to heater H. Moreover, the machine M controller uses this information/instructions so that engine runs at a sufficient speed for hydraulic pump 404 (operating off the engine PTO) to maintain sufficient hydraulic flow to hydraulic valve 406.

Hydraulic generator motor 408 is affixed to generator 410. Generator 410 could be any suitable generator, an example of which is available commercially from Linz Electric, Inc., Grimes, IA (https://www.linzelectric.us/pdf/60hz_alternators_catalog 2022.pdf incorporated fully herein by reference). Generator 410 is actuated by hydraulic generator motor 408 in order to produce sufficient electric energy to maintain the polyolefin pipe fusion heater H at least at a temperature sufficient to fuse two opposing ends of polyolefin pipe in a known manner as described herein.

In summary, engine/motor 410 of machine M, and thereby its PTO, runs at variable speeds as may be necessary to provide hydraulic power required by the various hydraulic systems of machine M. Hydraulic generator system 400, wherein hydraulic pump 404 operates off of the PTO, constantly provides hydraulic flow to hydraulic generator pump 408 by metering hydraulic flow at/through hydraulic generator valve 406. Since hydraulic flow is metered by hydraulic valve 406 to provide constant, consistent/steady/even flow of hydraulic fluid, hydraulic generator motor 408 runs (is thus adapted to run) at a constant desired speed necessary to actuate generator 402 in order to produce sufficient electric energy to maintain heater H at least at a temperature sufficient to fuse two opposing ends of polyolefin pipe regardless of the speed of the engine/motor 410.

### Boom Linkages

Turning back to FIGS. 1-3, mirrored parallel linkages 500 connected by a transverse cross support 560 form a boom B used to support and manipulate structures such as the indexer 600 and carriage 700 of a pipe fusion machine M.

Looking at FIGS. 3 and 5-9, the horizontal platform wings 121 with upright flanges 123 and parallel brackets 125 form horizontal back to front channels 129 on the sides of the machine M. The parallel linkages 500 are aligned with the channels 129. Attachment plates 502 of the linkages 500 have rear and front ends 503 and 504, respectively, affixed to the parallel brackets 125 on corresponding sides 303 and 304 of the turntable assembly 400.

Each linkage 500 includes an articulator 510 and an extender 520. The articulators 510 shown are plates 511 of triangular shape rotating on pivots 512 at the rear of the channel 129. The extenders 520 shown are straight outer tubular arms 522 extending forwardly from the upper ends of respective articulator plates 511 with straight telescoping inner tubular arms 540 extending and retracting from the free ends 543 of the outer tubular arms 522. Connectors 544 at the terminal ends 542 of respective telescoping inner tubular arms 540 define connection apertures 546. The connected articulator plates 511 and extender arms 522 shown form an articulator arm 530 with a dogleg-shape. The cross support 560 affixed to the outer tubular arms 522 proximate their terminal ends 526 assures simultaneous rotation of the linkages 500 and strengthens the boom B.

Each linkage 500 also includes a knuckle 550, as shown operable in a three-point configuration. The first point is the center axis of the aperture 546 at the terminal end 526 of the telescoping tubular arm 540. The second point is the pivot point of the cylinder 552 hinged below its respective telescoping inner tubular arm 540. The third point is the connection pin 553 on the piston associated with the cylinder 552.

Each linkage 500 employs three piston/cylinder combinations 532, 548 and 552. The first combination 532 is pivotally connected between an extender arm 522 and its respective attachment plate 502, thus facilitating raising or lowering the boom B. The second combination 548 is aligned in the extender 520 and connected between the outer and inner arms 522 and 540 of the extender 520, thus facilitating lengthening and shortening the boom B. As discussed above, the third combination 552 is hinged below its respective telescoping tubular arm 540 so the connection pin 553 on the piston is free for pivotal engagement with a structure to be manipulated, thus facilitating rotational orientation or tilting of the structure about the corresponding connectors 544 at terminal ends 526 of the boom B to horizontal or a desired angle from horizontal in order to, for example, maintain the orientation of the pivoted structure level with respect to the ground surface.

This arrangement gives an operator many tools for positioning a carriage assembly 700 and its jaws 800 over an object, such as a pipe stick S, to be lifted or secured by the jaws 800. That is, the operator may utilize the articulator 510, the extender 520, the knuckles 550, the swing or slew of the turntable assembly 400 and the movement of the machine M on the tracks 200 as often as necessary, simultaneously or otherwise, for positioning and orienting the jaws 800 over the object to be gripped.

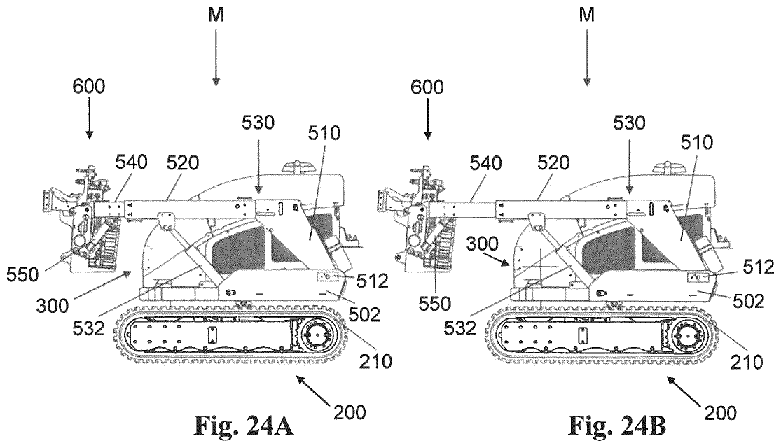

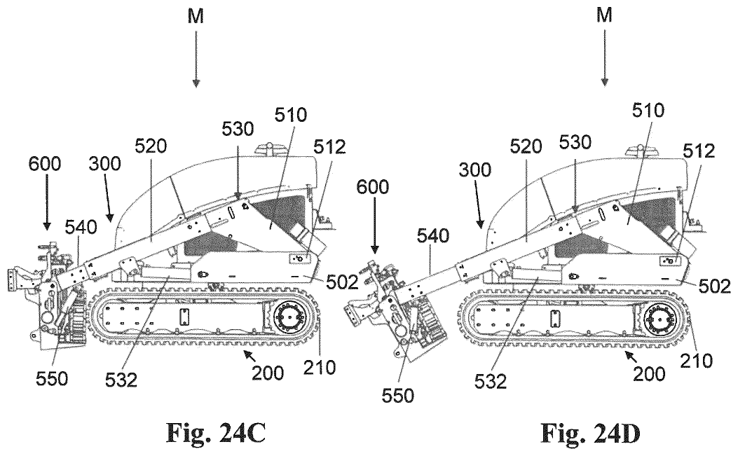

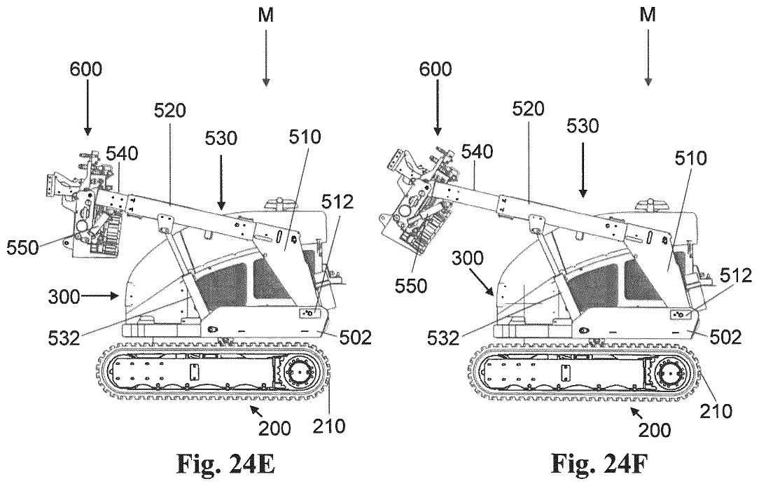

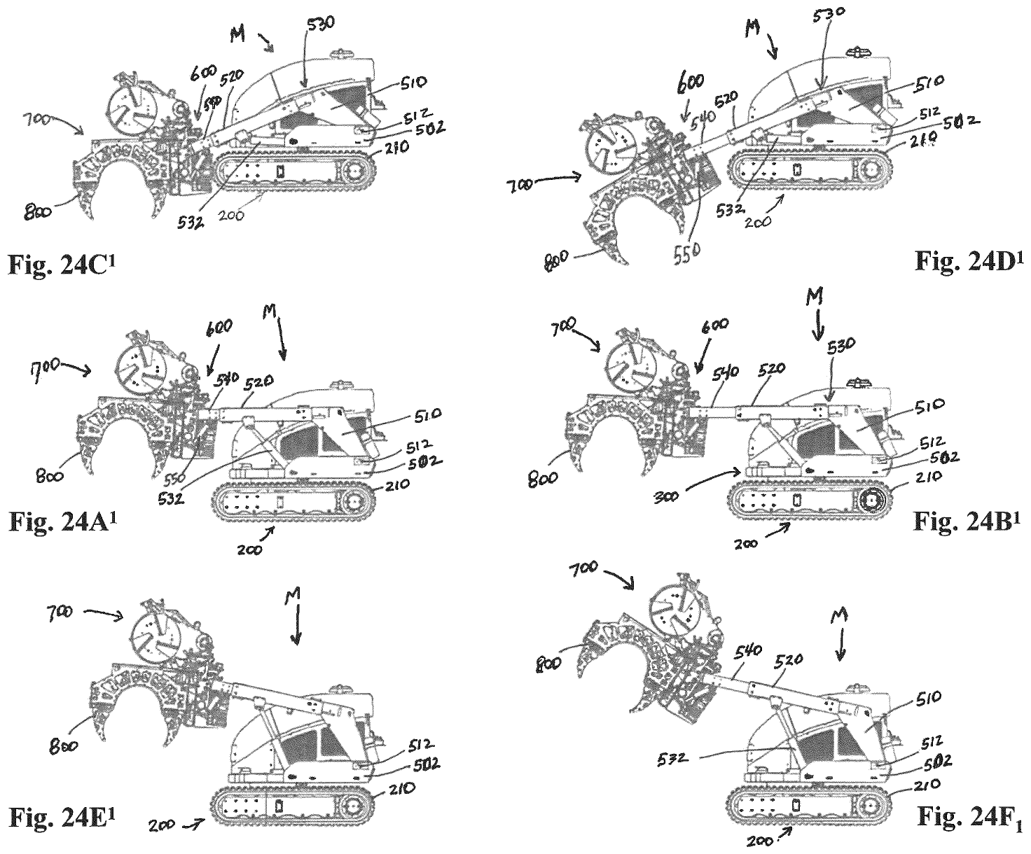

See, as examples of some of the possible orientations, FIGS. 24A-F, 24A′-F′ and 25A-B.

### Indexer

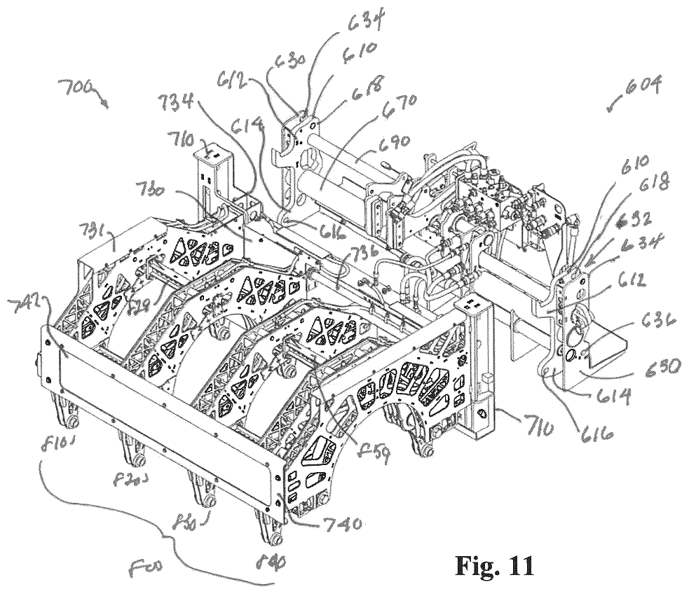

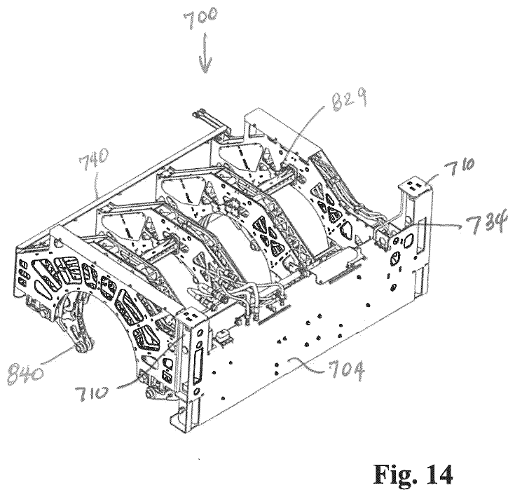

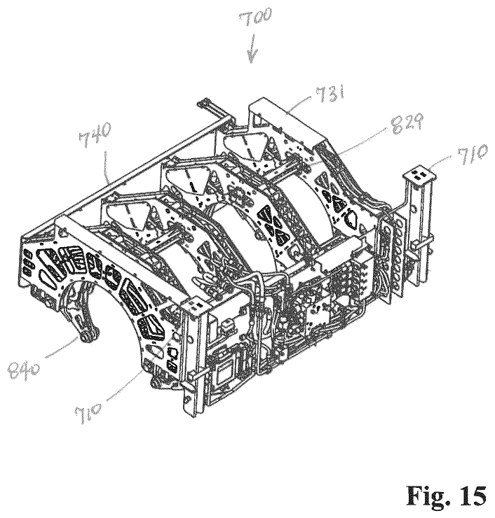

Looking at FIGS. 11-15, an indexer 600 has front and rear ends 602 and 604 and left and right indexer support members 610. The support members 610 have forwardly extending mounting hooks 612 and mounting tabs 614. The tabs 614 define respective mounting apertures 616. The support members 610 also have respective arm pin apertures 618 and inner knuckle actuator apertures 620.

Outer plates 630 are spaced apart from and parallel to respective indexer support members 610, forming receptacles 632 therebetween for receiving respective connectors 544 on the inner tubular arms 540. The outer plates 630 also have respective arm pin apertures 634 and outer knuckle actuator apertures 636 (FIG. 11).

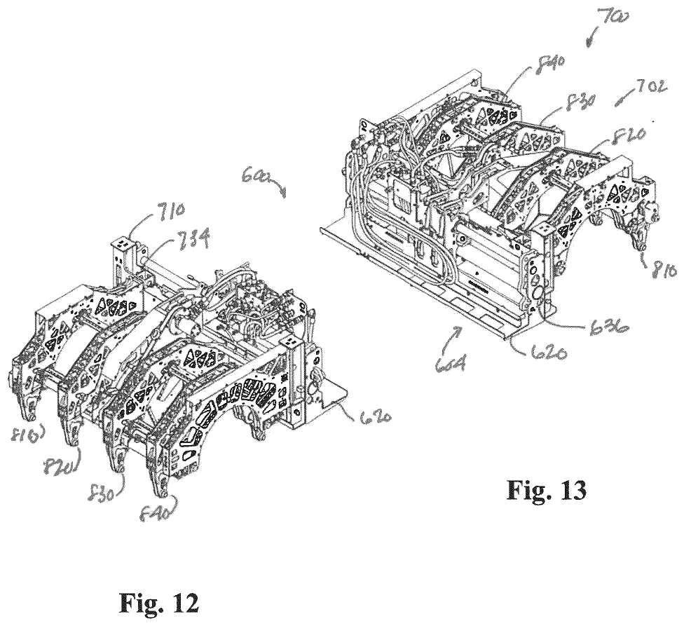

A center longitudinal indexer rod 670 (FIGS. 11, 12) connects the indexer support members 610. A lower longitudinal indexer rod 680 (FIG. 11) is connected to the left indexer support member 610 and an upper longitudinal indexer rod 690 is connected to the right indexer support member 610. A heater swing cylinder 692 and a facer swing cylinder 693 are supported on the upper longitudinal indexer rod 690 by a heater arm 694 and a facer arm 696, respectively (FIG. 11).

### Carriage

Turning now to FIGS. 11-15, a carriage 700 is configured for removable connection to the indexer 600. The carriage 700 has front and rear ends 702 and 704, left and right rear corner carriage frame members 710 and a rear cover 706 extending across the rear end 702 of the carriage 700 from one frame member 710 to the other (FIG. 11).

The rear cover 706 has hook slots 712 for receiving respective forwardly extending mounting hooks 612 of the indexer 600 and tab slots 714 for receiving the forwardly extending mounting tabs 614 of the indexer support members 610. The carriage frame members 710 also have arm pin apertures 718.

The forwardly extending mounting hooks 612 and mounting tabs 614 of the indexer 600 cooperate with the hook slots 712 and tab slots 714 of the carriage 700 to facilitate an easy connect and disconnect of the carriage 700 to the indexer 600. Connector pins 720 are received in respective arm pin apertures 718 of the carriage frame members 710 and pass through the aligned arm pin apertures 618 in the forwardly extending mounting tabs 614 on the indexer support members 610 when the carriage 700 is positioned to connect with the indexer 600.

As best seen in FIGS. 11 and 12, the width of the carriage 700 is less than the width of the indexer 600 but the distance between the carriage frame members 710 and the indexer support members 610 is the same. The right carriage frame member 710 is whitened by a short inside portion 734 to make up the difference. A left carriage support plate 730 extends forwardly from the left carriage frame member 710 to provide a left support surface 731 to support the carriage 700 when the carriage 700 is disconnected and inverted. A right carriage support plate 730 extends forwardly from the short inside portion 734 of the right carriage frame member 710 to provide a right support surface 731 to support the carriage 700 when the carriage 700 is disconnected and inverted. The right support plate is above an outer slider jaw 802 of the carriage 700. A guide rod 736 extends between the carriage frame members 710 and a sliding structure 738 is slidably mounted on guide rod 736.

As will be explained below in greater detail, the carriage 700 may be disconnected from the indexer 600 by removing the connector pins 720 from the arm pin apertures 618 and 718 and then pivoting the indexer assembly 600 to withdraw the mounting tabs 614 on the front of the indexer 600 from the tab slots 714 on the rear of the carriage 700. The mounting hooks 612 on the indexer 600 may then be disengaged and removed from the mounting hook slots 712 in the carriage 700 to disconnect the carriage 700 from the indexer 600.

### Jaws

Looking now at FIGS. 1-3 and 11-17, a plurality of jaws 800, including outer and inner slider jaws 810 and 820, an inner convertible jaw 830, and an outer fixed jaw 840, are mounted on the carriage 700.

The outer slider jaw 810 is adjacent to the left carriage support plate 630 and has a front surface 811, a top surface 813, and a rear surface 815. The inner slider jaw 820 is parallel to the outer slider jaw 810 and has a front surface 821, a top surface 823, and a rear surface 825. The rear surfaces 815 and 825 of the outer and inner slider jaws 810 and 820 are slidably mounted to the convertible sliding structure 738 of the carriage 700. A jaw connector 829 links the outer slider jaw 810 to the inner slider jaw 820 to insure that they slide together along the guide rod 736 of the carriage 700.

The outer fixed jaw 840 has a front surface 841, a top surface 843, and a rear surface 845. The rear surface 845 is connected to the right carriage frame member 710. The inner convertible jaw 830 is between the outer fixed jaw 840 and the inner slider jaw 820 and has a front surface 831, a top surface 833, and a rear surface 835. The rear surface 835 is affixed to the guide rod 736 of the carriage 700. A jaw connector link 849 optionally connects the outer fixed jaw 840 to the inner convertible jaw 830 for facilitating a 2×2 configuration of the carriage 700 in which the inner convertible jaw 830 is locked to the outer fixed jaw 840.

Alternatively, the jaw connector link 849 may be removed and relocated for connecting the inner convertible jaw 830 to the inner slider jaw 820, thus assuring that the outer slider jaw 810, the inner slider jaw 820, and the inner convertible jaw 830 will slide together along the guide rod 736 in a 3×1 configuration of the carriage 700.

A front connector plate 740, as shown with an optional window 742, is affixed to the front surfaces 811, 821, 831, and 841 of the jaws 810, 820, 830 and 840.

The outer slider jaw 810, the inner slider jaw 820, the inner convertible jaw 830, and the outer fixed jaw 840 may be similarly constructed. The following discussion of the outer fixed jaw 840 therefore applies to the outer slider jaw 810, the inner slider jaw 820, and the inner convertible jaw 830 and similar components of the plurality of jaws 800 will retain the same element numbers for the similar elements.

In FIGS. 16 and 17, the lower quarter jaws 870 or replacement quarter jaws 870′are opposite hand. Knowing this opposite hand relationship, the following discussion also applies the same element numbers of FIG. 17 for the similar elements of FIG. 16.

In FIG. 17, a carriage 700 handles a pipe P of relatively large diameter. The left side of the outer fixed jaw 840 has an upper half jaw 850 with front and rear ends 851 and 853 and an arcuate gripping surface 855 spanning therebetween. The radius 857 of the arcuate gripping surface 855 closely accommodates the top surface of the relatively large diameter pipe P. Opposite hand removable lower quarter jaws 870 have gripping surfaces 875 of a radius that closely accommodates opposite lower portions of the bottom surface of the relatively large diameter pipe P.

In FIG. 16, the same carriage 700 handles a pipe P′ of relatively small diameter 857′ because an upper half jaw insert 850′ and lower replacement quarter jaws 870′ are used. The arcuate gripping surface 855 of the upper half jaw 850 closely accommodates the top surface of the upper half jaw insert 850′. The half jaw insert 850′ has an arcuate gripping surface 855′ that closely accommodates the top surface of the relatively small diameter pipe. The opposite hand replacement quarter jaws 870′ have gripping surfaces 875′ of a radius that closely accommodates opposite lower portions of the bottom surface of the relatively small diameter pipe P′.

Returning to FIG. 17, a quarter jaw 870 is removably pivotally connected at its upper end to a Y-shaped link 860 by a pin 861. One arm of the Y-shaped link 860 is connected to the inside of a respective end 851 or 853 of the upper half jaw 850 at a first pivot point 871. The other arm of the Y-shaped link 860 is connected to an actuator 859 mounted in the outside end of the upper half jaw 850 at a second pivot point 872. The bottom of the leg of the Y-shaped link 860 is removably engaged by a support pin 874 in a drop-in opening 876 in the outer perimeter of the quarter jaw 870 at a third pivot point 873. A piston/cylinder combination of the actuator 859 operates the link 860 to selectively manipulate the quarter jaw 870 between open and closed positions.

Returning to FIG. 16, the carriage 700 of FIG. 17 is gripping a smaller diameter pipe P′ with the upper half jaw insert 850′ located on the arcuate surface 855 of the outer fixed jaw 840 and with the replacement quarter jaws 870′ instead of the removable quarter jaws 870 to provide a second effective radius 857′in the outer fixed jaw 840. The same Y-shaped link 860 cooperates with the upper half jaw insert 850′ and the replacement quarter jaws 870′ to grip the smaller diameter pipe.

The availability of an upper half jaw insert 850′ and the replacement quarter jaws 870′ can, for example, allow the same carriage 700 to handle pipes having an outside radius 857′ that is substantially equal to half that of the first outside radius 857.

### Hydraulic Systems

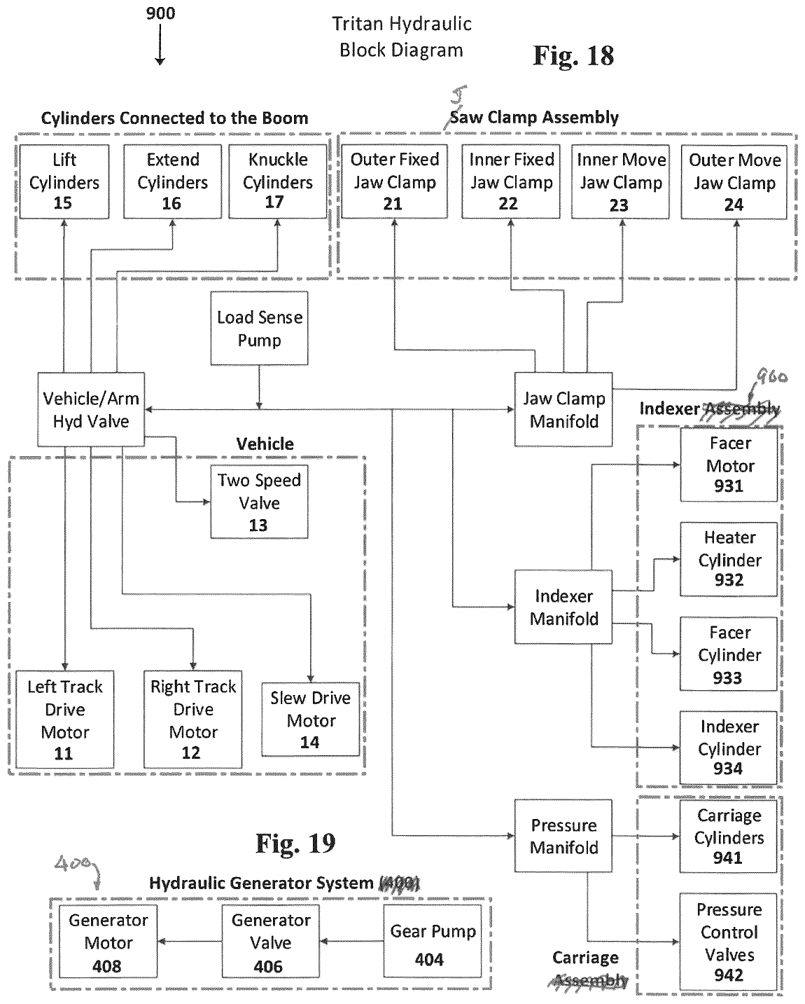

Turning now to FIG. 18, various machine hydraulic systems are described in relation to a single hydraulic block diagram 900.

A vehicle/arm hydraulic valve 910 located on the vehicle frame behind the hydraulic tank distributes hydraulic fluid to vehicle drive equipment including the left and right track drive motors 911 and 912 located on the rear of their respective tracks, a two speed valve 913 located on the vehicle to independently switch the tracks between low and high speeds and the swing drive motor 914 located near the right trackwheel on the circular base of the turntable to drive the turntable clockwise or counterclockwise in a horizontal plane.

The vehicle/arm hydraulic valve 910 also distributes hydraulic fluid to the boom operating cylinders including the lift, extend and knuckle cylinders 915, 916 and 917 on the linkage 500 to raise and lower the boom, to the extend and retract the telescoping arm and to articulate the indexer/carriage combination, respectively.

A jaw clamp manifold 920 located on the carriage assembly distributes hydraulic fluid to independently open and close the four jaw clamps of the jaw clamp assembly including the outer and inner fixed jaw clamps 921 and 922 and the inner and outer sliding jaw clamps 923 and 924.

An indexer manifold 930 located on the top of the indexer 600 distributes hydraulic fluid to the facer motor 931 which is located on the indexer 600 to hydraulically drive the facer F, the heater and facer cylinders 932 and 933 to independently rotate the facer F and the heater H into and out of alignment with the pipe and pipeline, respectively, and to the indexer cylinder 934 located on the back of the indexer 600 to align the facer F and the heater H between the fixed and moving jaws for insertion between the pipe ends.

A pressure manifold 940 located on the carriage assembly 700 distributes hydraulic fluid to the carriage assembly the operating equipment including the carriage cylinders 941 located on the guide rails to move the carriage assembly left and right and the carriage pressure control valves 942 which are a part of the pressure manifold 940.

A load sense pump 950 is located on the rear of and coupled to the engine. The load sense pump 950 assures that the pressure needed to either operate the tracks or to operate all of the other hydraulic equipment of the overall hydraulic system 900, depending on whether the machine is in a traveling or working mode, is available.

As seen in FIG. 19, the hydraulic generator system 400 includes a hydraulic pump 404 mounted on the PTO of the engine, the generator valve 406 mounted in the vehicle, and the generator motor 408 on the front of the generator 410. The hydraulic generator system 400 constantly provides hydraulic flow to hydraulic generator pump 408 by metering hydraulic flow through hydraulic generator valve 406 so that hydraulic generator motor 408 runs at a constant desired speed necessary for generator 410 to produce sufficient electric energy to maintain heater H at least at a temperature sufficient to fuse two opposing ends of polyolefin pipe regardless of the speed of the engine/motor.

### Electrical Control Systems

Turning now to FIG. 20, various machine electrical control systems are described in relation to a single electrical block diagram 1000.

The vehicle controller 1010 is located in the frame of the vehicle. It communicates directly to the generator valve 404 and receives communications directly from a resistive thermostatic device (RTD) 1012, a sensor monitoring the heater H. It communicates directly to the indexer manifold 930 on top of the indexer 600 regarding operation of the indexer manifold components. It directly receives communications for each track from track controls 1014 on the back of the vehicle display and from several hydraulic pressure sensors 1015 located on the vehicle near the hydraulic pump and valve. Regarding engine speed errors, the vehicle controller 1010 on the vehicle is in two way communication with the engine controller 1016 located on the engine.

The carriage controller 1020 located on the back part of the carriage 700 is part of a network connecting the vehicle controller 1010 and the carriage controller 1020 together with an indexer position sensor 1022 located inside the indexer tube where the heater H and facer F are in alignment and a carriage position sensor 1023 located below a carriage cylinder to indicate the horizontal location of the movable jaws. The indexer and carriage position sensors 1022 and 1023 are both linear transducers.

In addition to the network exchange, the carriage controller 1020 also receives information from hydraulic pressure sensors 1024 which are part of the pressure manifold 940 regarding the opened/closed condition of the jaws 800 and from the jaw configuration sensor 1025 located on the carriage fixed jaw 840 to determine if the jaws 800 are in [2+2] or [3+1] configuration. The carriage controller 1020 is also in two-way communication with the carriage close pressure sensor 1025, a part of the pressure manifold 940, about the pressure applied to the molten ends of pipe.

The carriage controller 1020 also communicates information to the pressure manifold 940 and the jaw clamp manifold 920 and receives information from arc sensors 1028 monitoring the rotational position of the facer and heater arms.

The vehicle controller 1010 also shares information in another network including the PCM assembly 1030 located on the vehicle frame and monitoring the heater voltage, the power control module monitoring the heater voltage, the vehicle arm hydraulic valve 1040 located on the vehicle frame, the vehicle display 1050 fixed to the outside of the machine M and the control tablet 1060, a 7 inch tablet dedicated on the vehicle.

### Operator Remote Controller

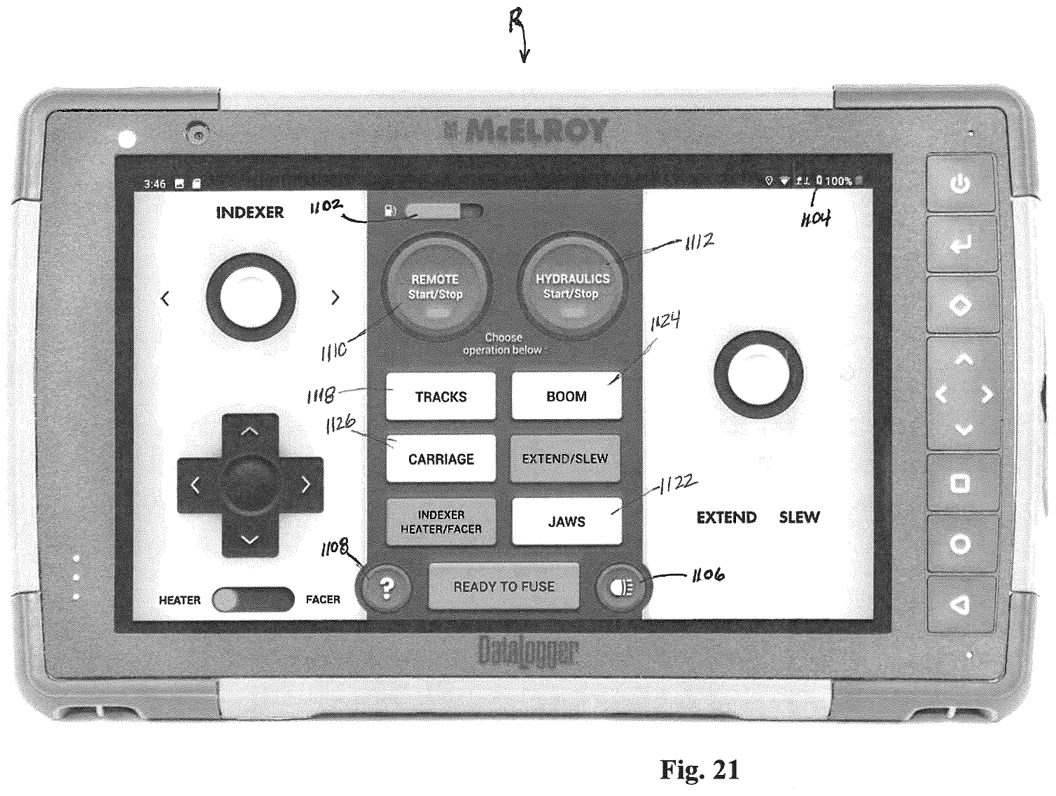

With reference to FIGS. 21, 22, 23A, and 23B, remote operation of the machine M next described. The machine M, in a preferred arrangement, is designed to be operated by a remote controller R. All hydraulic and fusion operations/capabilities of the machine M can be operated from the remote R. This remote R is, in a preferred arrangement, a touch screen tablet computer which communicates with the vehicle controller wirelessly via Bluetooth. Such wireless communications are known to those of skill in the art.

The remote R, in a preferred embodiment includes a removable battery pack which may be charged (recharged) by the machine M. In a preferred use, two (or more) batteries could be used such that one is inserted into and powering the remote R, while another one (or perhaps more) is docked in the machine R and recharging. Another charged (recharged) battery could, alternatively, be available to swap out with the battery powering remote R if the one docked has not yet finished charging. Alternatively, the battery (batteries) could be charged by an electricity source using an AC adapter in a known manner.

The general layout of the remote R, in a preferred embodiment, includes multiple touch screen options selectable by an operator touching virtual buttons from provided menus displayed on the remote R. Each available screen will contain certain general information relating to status of the machine M and/or the remote R. This includes a fuel level indicator 1102 (diesel in the preferred embodiment), battery status of remote R 1104, a virtual button 1106 to turn on or off the headlights and running lights of machine M, and a virtual button 1108 which initiates a “help” menu in the event the operator encounters a problem or just needs instruction on the operation of the machine M and/or the remote R. Other virtual buttons available on all screens of remote R include a virtual button 1110 which allows the engine of machine M to be started or, conversely, stopped (shut-off). However, in the preferred embodiment, a key must be inserted in machine M and turned to an “on” position in order to enable this functionality on button 1110. Virtual button 1112 initiates communication between remote R and the controllers of the hydraulics system on machine M to either allow functionality via remote R, or conversely, disable hydraulic functionality of the hydraulic system or remote R. Button 1112 thereby acts as a “disable” button for hydraulic functionality. This may be useful, such as for non-limiting example, if the operator were to step away from machine M or set remote R down for some reason, or even to manually address an issue on machine M.

Also on remote R is a virtual button 1114 to activate a datalogger function. Datalogger is a software data storage and retrieval system which is the subject of U.S. Pat. No. 6,212,748, incorporated fully herein by reference, as well as https://wvvw.mcelroy.com/en/fusion/datalogger.htm also incorporated fully herein by reference.

Six virtual buttons (1118-1128) also appear on each screen of remote R in a preferred arrangement. Virtual buttons 1118-1128 relate to operation functions/capabilities of machine M. These buttons include: tracks 1118 (which provides operation of the drive tracks of machine M); indexing 1120; jaws 1122 (which allows jaw movement operations); boom 1124; carriage 1126; and, rain tracking 1128. Selection of each of these buttons brings up a screen providing the operator access to the functionality identified. Two different function screens may are provided at any time. The operator may select any two function screens from the options provided. The functions of each of these virtual buttons are described further below.

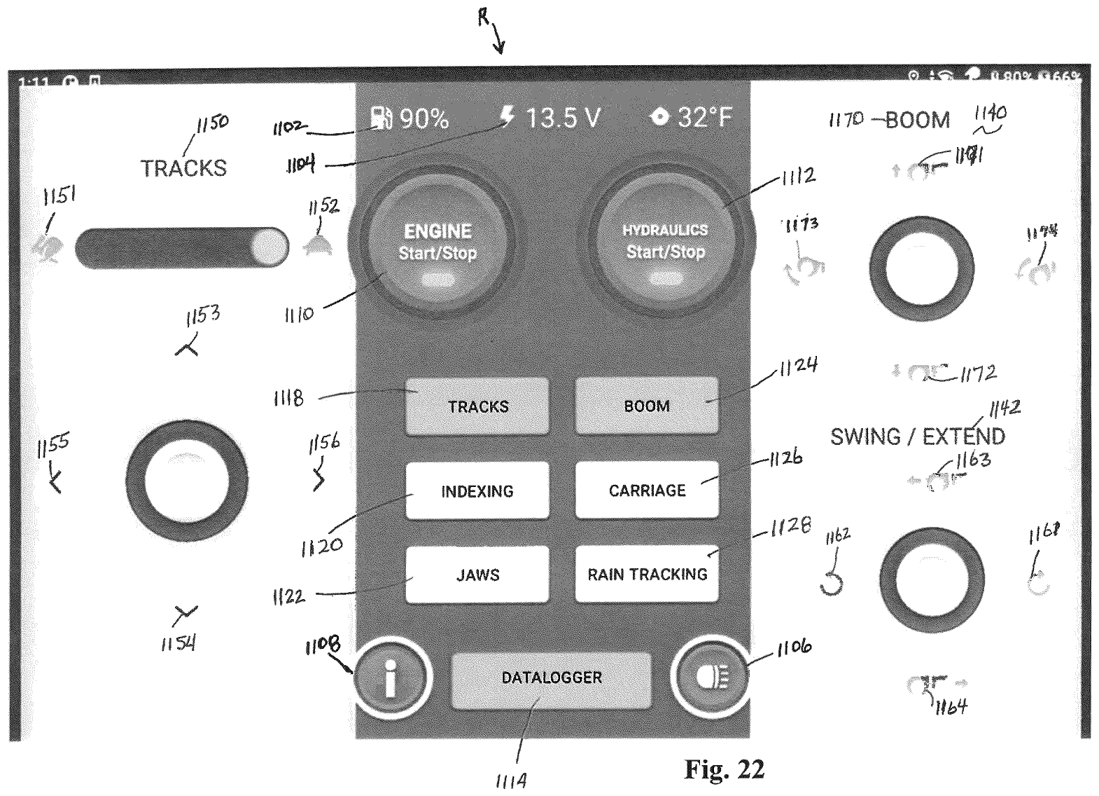

FIG. 22 illustrates the screenshot on the machine display in which the operator is operating the left 210 and right tracks 210 and the swing/extend components 300/500 of the machine M. On the tracks side 1150, the operator can choose to operate the tracks 1150 at high speed 1151 or low-speed 1152, moving forward 1153 or in reverse 1154 and turning left 1155 or right 1156. On the Boom/Swing/Extend side 1150, the operator can choose to swing or rotate 1142 the turntable 300 clockwise 1161 or counterclockwise 1162 and can extend 1163 or retract 1164, the telescoping arm of the linkage 500. On the boom operation 1170, the operator can choose to raise 1171 the boom or lower 1172 the boom of the linkage 500. The operator may also knuckle the carriage 800 up 1173 or down 1174.

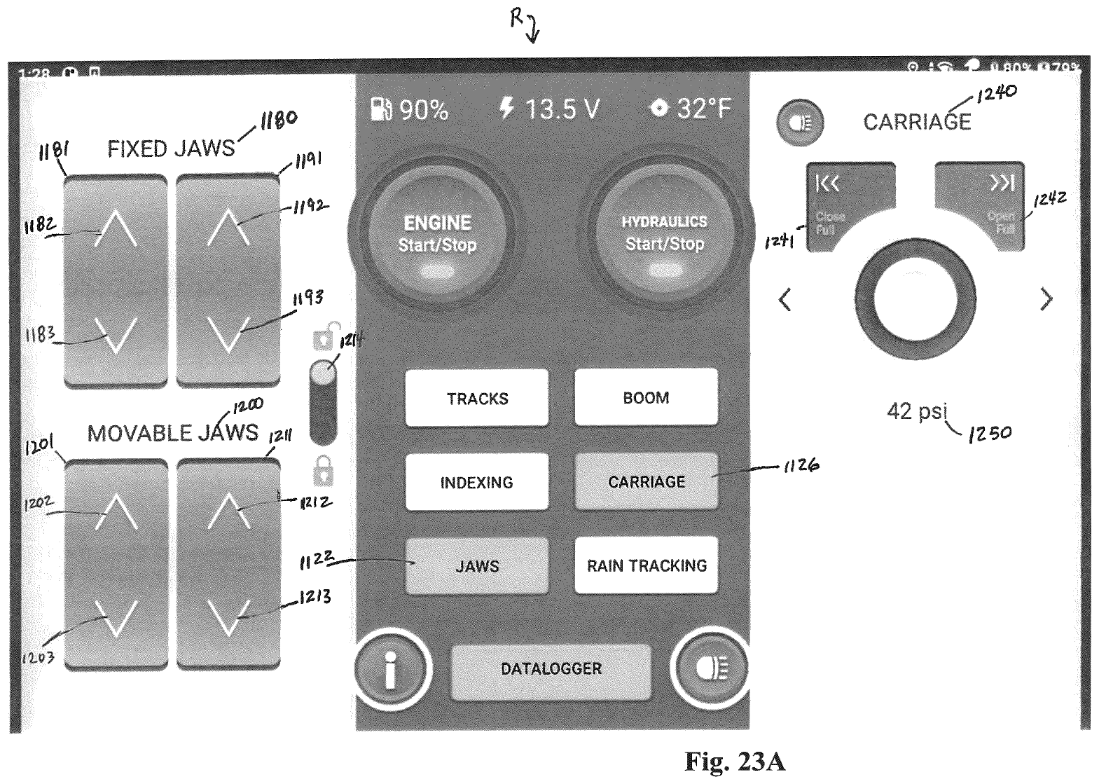

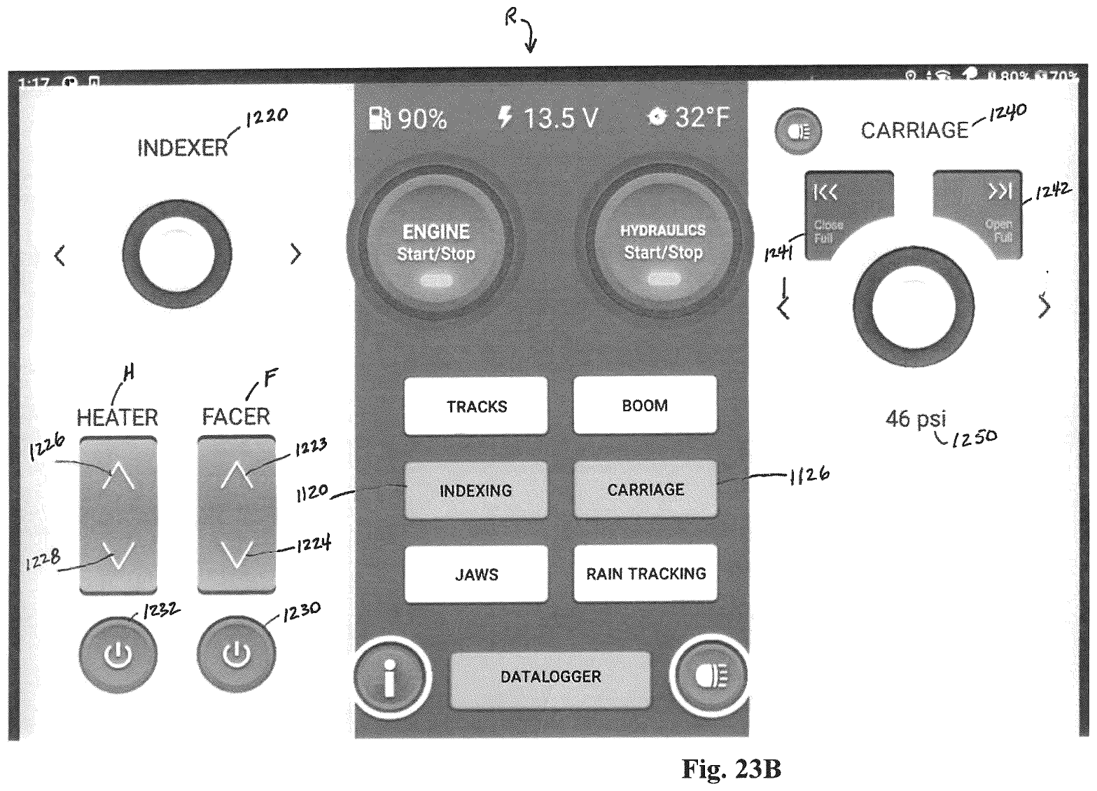

FIG. 23A illustrates the screenshot on the machine display in which the operator is operating the jaws 800 of the carriage 700. On the jaws side 1180, the operator can choose to independently operate two fixed jaws 1181/1191 to open 1182/1192 or close 1183/1193 and the operator can choose to independently operate at 1200 two movable jaws, 1201/1211 to open 1202/1212 or close 1203/1213. As shown, the operator has chosen jaws 1214 shown to be unlocked.

FIG. 23B illustrates the screenshot on the machine display in which the operator is operating the indexer 600 to position the heater H or facer F in relation to the jaws and to cause the carriage 1240 to vary the facing pressure 1250. On the indexer side 1220 the operator can choose to control the heater H or the facer F and has chosen the facer F. The operator can cause the facer to move on the indexer guide rod to the left 1221 or to the right 1222. Once the facer F is aligned the operator can rotate the facer upwardly 1223 away from or downwardly 1224 into alignment between the jaws 800. Similarly, the operator can control heater H to rate upwardly 1226 away from or downwardly 1228 into alignment between the jaws 800. The operator may also control power to the facer F at 1230 or the heater H at 1232.

On the carriage 1240 and facing pressure 1250 side of both FIGS. 23A and 23B, the operator can close 1241 the jaws on or open 1242 the jaws away from the facer F and control 1250 the facing pressure applied to the facer F.

### Operation and Methods

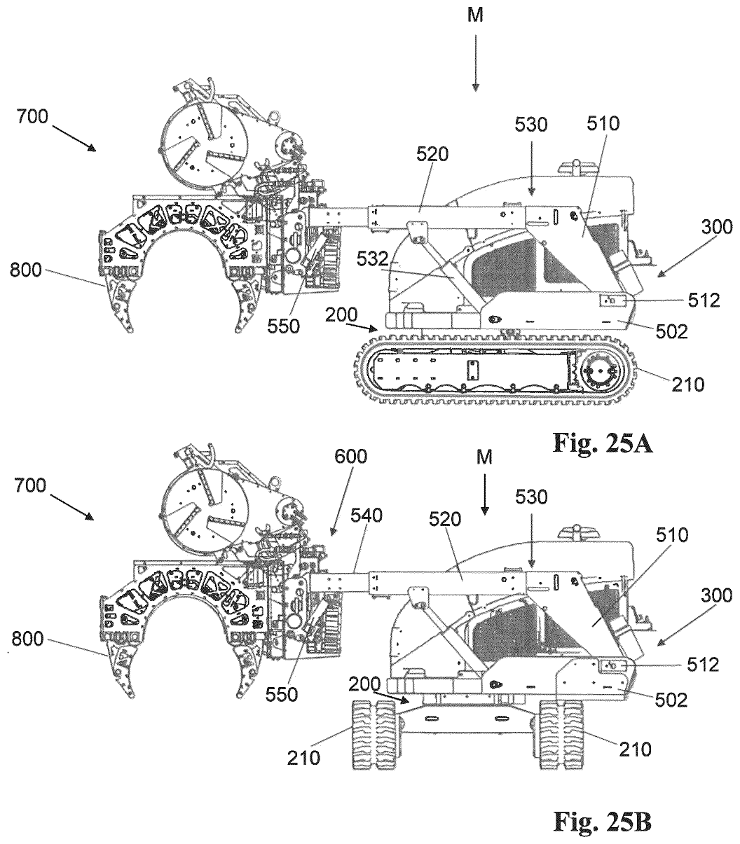

Referring now to FIGS. 24A-25B, shown is an elevation view of the pipe fusing machine M of the invention. As discussed above, with reference to the linkages 500, an operator has the ability to position carriage 700 and jaws 800 over an object to be lifted or secured by jaws 800, such as a pipe. In particular, the operator may utilize boom articulators 530, boom extenders 520, knuckles 550, the slew or swing of the turntable 300 and the movement of the machine M on the chassis 200 for positioning jaws 800 at a desired location.

Referring now to FIGS. 24A (and 24A¹), the machine M of the invention is in a neutral configuration in which the boom B is shown in a horizontal configuration. The Indexer assembly 600 is in a near vertical orientation as positioned by knuckle 550. One adjustment that may be made by an operator is to manipulate boom extender 543 for telescopically extending inner tubular arms 540 for locating indexing unit 600 a further distance away from the machine of the invention, as shown in FIGS. 24B (and 24B¹).

Indexer 600 and attached carriage (not shown) may be positioned closer to a pipe by lowering extenders 520. Referring now to FIGS. 24C (and 24C¹), shown is a configuration of the machine of the invention wherein left boom 520b can be seen lowered to a position below horizontal. In the configuration shown in FIG. 24C, knuckles 550 have been extended for positioning indexer 600 at an orientation that is approximately vertical with respect to a ground surface.

Referring now to FIGS. 24D (and 24D¹), shown is a configuration wherein boom extenders 520 remain in a lowered position. In one embodiment, the lowered position is 15 degrees below horizontal. In this configuration, boom extenders 548 are activated to extend inner tubular arms 540 outwardly from boom extenders 520 to position indexer 600 further away from the machine of the invention. As shown in FIGS. 24D (and 24D¹), indexer 600 is positioned by knuckles 550 to a position that is approximately a right angle to boom extenders 520.

Referring now to FIGS. 24E (and 24E¹) and 24F (and 24F¹), the machine M of the invention is shown in a configuration wherein boom extenders 520 are elevated to a position above horizontal. In this configuration, the boom extenders 520 may be elevated 20 degrees above horizontal, although other amounts of deviation from horizontal are possible. In the raised configuration of FIGS. 24E, 24E¹, 24F and 24F¹, left boom extender 520 can be seen supporting indexer 600. In FIGS. 24E and 24E¹, indexer 600 is maintained at an approximately vertical orientation by knuckles 550. In FIGS. 24F and 24F¹, indexer 600 is shown rotated such that the bottom of indexer 600 is further away from the machine of the invention.

Therefore, it can be seen that an operator may manipulate the machine M of the invention by raising and lowering boom extenders 520 with boom articulator 532, or by extending or retracting the inner tubular arms 540 from boom extenders 520, and an operator may manipulate the angular orientation of indexer 600 and any attached structure with knuckles 550.

Referring now to FIGS. 25A and 25B, the indexer 600 and carriage 700 may be additionally orientationally manipulated by an operator by utilizing slew or swing of turntable 300. Referring now to FIG. 25A, the machine M of the invention is shown in a neutral configuration with the boom extender 520 approximately horizontal and aligned or parallel with tracks 210 of chassis 200.

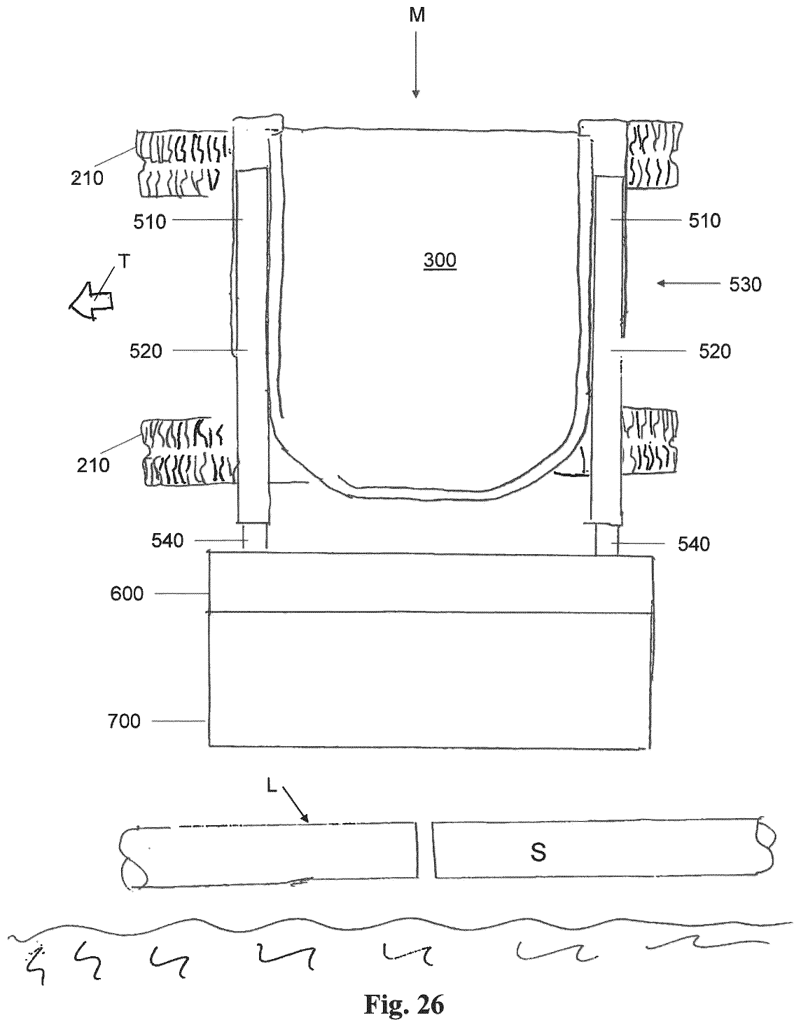

Referring to FIG. 25B, the machine M of the invention is shown in a neutral configuration with boom extender 520 approximately horizontally rotated, along with turntable 300, 90 degrees with respect to tracks 210 of chassis 200. As can be appreciated, the slewing or swingability of turntable 300 allows an operator to drive the machine M of the invention parallel to a string of pipe L or pipe stick sections S while positioning turntable 300 such that boom extenders 520 are perpendicular to the direction of travel T as shown in FIG. 26. In this way, an operator may fuse multiple sections of pipe L while directing the machine of the invention to traverse a distance (along the length) of the pipe L. The operator has the ability to fine tune the position of carriage 700 and jaws 800 by manipulating the above discussed adjustments that are possible through the use of articulators 530, boom extenders 520, inner tubular members 540, and knuckle extender 550.

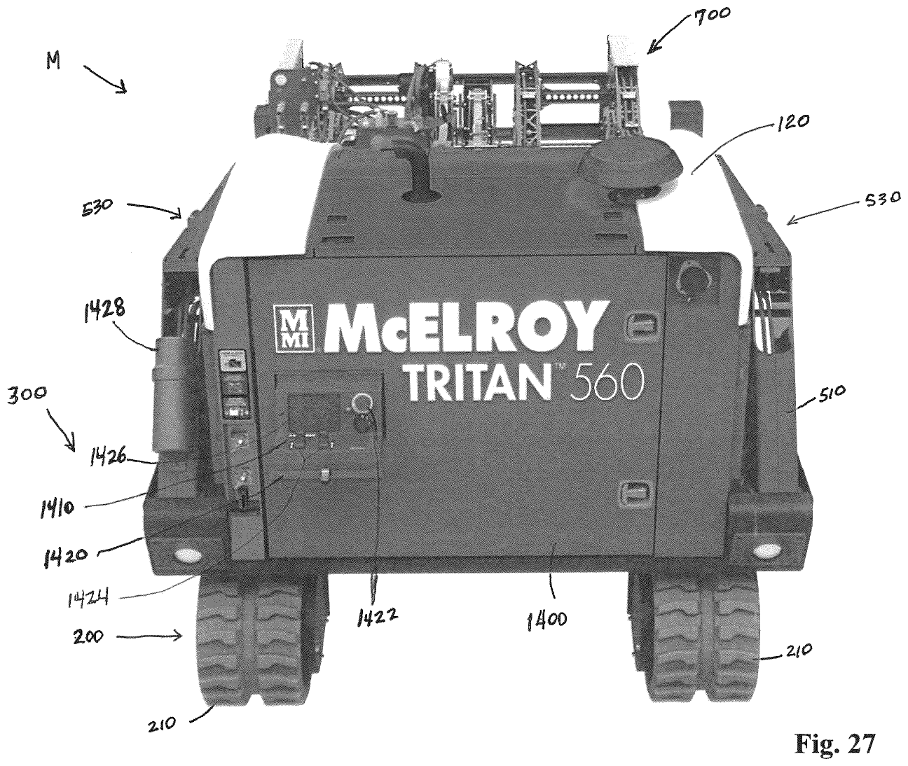

Referring now to FIG. 27, shown is a rear view of the machine M including turntable 300. Rear portions of the tracks 210 and chassis 200 are visible beneath turntable 300. Turntable 300 includes cowling 120 having a rear surface 1400. Rear surface 1400 includes a manual control center 1410 that may be accessed by opening a hinged cover 1420. Hinged cover 1420 is shown in the open position in FIG. 27. Manual control center 1410 includes an on/off button 1422, toggles 1424 for manual control of the tracks 210 of chassis 200 and display screen 1426 for providing information to an operator. A storage case 1428 may be provided for the storage of materials, such as written documentation or user's manuals.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)— (a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, it is apparent that there has been provided, in accordance with the invention, a machine and components thereof and a method for the end-to-end fusion of two axially aligned pipes that fully satisfies the objects, aims and advantages set forth above While the invention has been described in conjunction with specific embodiments thereof, it is evident that many alternatives, modifications and variations will be apparent to those skilled in the art and in light of the foregoing description. Accordingly, it is intended to embrace all such alternatives, modifications and additions as fall within the spirit of the appended claims.

What is claimed is:

1. A pipe fusion machine comprising:
a pair of tracks supporting a chassis;
a horizontal turntable mounted for reversible rotation relative to said chassis; and
a boom pivotally attached at a rear of, and extending forwardly of a front of, said turntable, said boom enabling manipulation of elevations and distances of a free end thereof beyond a footprint of said tracks, said free end of said boom adapted for pivotal mounting thereon of a pipe fusion tool.

2. The pipe fusion machine according to claim 1, said pipe fusion tool comprising an indexer articulable on said free end of said boom and supporting a pipe-end facer and a pipe-end heater for independent orientation into and out of alignment with the ends of pipes to be fused.

3. The pipe fusion machine according to claim 2 further comprising a carriage removably rigidly connectible to said indexer for articulation in unison therewith, said carriage supporting fixed and sliding jaws adapted to grip the ends of pipes to be fused for relative reciprocal movement of one end of a pipe toward and away from an end of a pipeline during a pipe fusion process.

4. The pipe fusion machine according to claim 3, each of said jaws comprising:
an upper half jaw with a semi-cylindrical inner surface;
lower left and right quarter jaws each with an inner surface of radius equal to a radius of said semi-cylindrical inner surface; and
left and right links, each said link being pivotally engaged at an upper end thereof to a corresponding lower portion of said upper half jaw and pivotally engageable at a lower end thereof with a corresponding quarter jaw,
whereby said upper jaw inner surface and said corresponding lower quarter jaw inner surfaces cooperate to conform to the outer surface of a pipe having an outer surface of radius equal to said half jaw radius as the pipe is being gripped thereby.

5. The pipe fusion machine according to claim 4, each of said jaws further comprising an actuator co-operable with a respective said link for selectively manipulating said quarter jaw between open and closed positions.

6. The pipe fusion machine according to claim 4, each of said jaws further comprising:
an upper half jaw insert having an outer radius equal to said radius of said semi-cylindrical inner surface and an inner radius less than said inner radius of said semi-cylindrical inner surface; and
replacement lower left and right quarter jaws each with an inner surface of radius equal to an inner radius of said upper half jaw insert;
whereby said inner surface of said upper jaw insert and said corresponding inner surfaces of said lower quarter jaw replacement cooperate to conform to the outer surface of a pipe having an outer surface of radius less than said radius of the pipe being gripped.

7. The pipe fusion machine according to claim 1, a range of said reversible rotation of said horizontal turntable being unlimited.

8. The pipe fusion machine according to claim 1 further comprising:
a heater adapted for fusing two opposing ends of polyolefin pipe;
a hydraulic generator motor adapted to actuate a generator;
a supply of hydraulic fluid;
a hydraulic pump adapted to receive said supply of hydraulic fluid at a first flow and distribute said supply of hydraulic fluid at a second flow;
a generator valve adapted to receive said hydraulic fluid at said second flow and meter said fluid at a hydraulic fluid flow sufficient to run said hydraulic generator motor at a constant desired speed;
a generator adapted to be actuated by said hydraulic generator motor in order to produce sufficient electric energy to maintain said heater at least at a temperature sufficient to fuse said two opposing ends of said polyolefin pipe.

9. The pipe fusion machine of claim 8 wherein said hydraulic pump is driven by a motor and wherein said motor powers a power take off (PTO) and said hydraulic pump is driven by said PTO of said motor.

10. The pipe fusion machine of claim 9 wherein said hydraulic pump is mounted to said PTO of said motor.

11. The pipe fusion machine of claim 10 wherein said motor is adapted to run at variable speeds; and,
said hydraulic generator motor adapted to run at said constant desired speed to actuate said generator in order to produce sufficient electric energy to maintain said heater at least at a temperature sufficient to fuse said two opposing ends of said polyolefin pipe regardless of the speed of said motor.

12. The pipe fusion machine of claim 9 wherein said motor, said hydraulic pump, said generator valve, said hydraulic generator motor, and said generator are mounted to said turntable.

13. The pipe fusion machine of claim 9 wherein said generator is in direct electrical communication with said heater.

14. A pipe fusion machine comprising:
a horizontal chassis mounted on independently reversible drive tracks, said chassis being symmetrical with respect to an X-Z plane centered between said tracks;
a horizontal platform mounted above said chassis for reversible rotation about a Y-axis of said X-Z plane; and
a boom comprising left and right parallel linkages mirrored on opposite sides of and equidistant from said Y-axis, rear portions of said linkages being pivotally mounted on the platform for rotation on a first common X-axis rearward of said Y-axis, said left and right linkages being configured to simultaneously adjust elevations and distances of free ends thereof with said free ends aligned on a second common X-axis forward of said Y-axis and extending beyond a footprint of said tracks and chassis.

15. The pipe fusion machine according to claim 14, each said linkage comprising an articulator and a knuckle with an extender therebetween, said articulator being pivotally mounted on the platform, said extender being mounted for reciprocal longitudinal motion relative to a forward portion of said articulator and said knuckle being pivotally mounted on a free end of said extender.

16. A boom enabling manipulation of a pipe fusion machine tool from a horizontal platform of the machine, the boom comprising:
left and right mirrored parallel linkages on opposite sides of and equidistant from a Y-axis through the platform, rear portions of said linkages being pivotally mountable on the platform for rotation on a first common X-axis rearward of said Y-axis, said left and right linkages being configured to simultaneously adjust elevations and distances of free ends of said left and right linkages with said free ends aligned on a second common X-axis forward of the machine.

17. The boom according to claim 16, each said linkage comprising an articulator and a knuckle with an extender therebetween, said articulator being pivotally mounted on the platform, said extender being mounted for reciprocal longitudinal motion relative to a forward portion of said articulator and said knuckle being pivotally mounted on a free end of said extender.

18. An indexer enabling detachable connection of a carriage to the boom of a pipe fusion machine, the indexer comprising:
rear adapters configured for removable connection of the indexer on a free end of the boom, said adapters permitting articulation of the indexer on the free end of the boom about a horizontal axis extending perpendicular to the boom;
a center support rod extending transversely across the indexer forward of said rear adapters and between end plates of the indexer;
an upper indexer rod extending between said end plates and parallel to said center support rod;
a lower indexer rod extending inwardly from one of said end plates and parallel to said center support rod;
a pipe end facer and a pipe heater hanging from said upper indexer rod for independent rotation in spaced-apart parallel planes; and
front adapters configured for removable rigid connection of the carriage to the indexer.

19. The indexer according to claim 18, the carriage comprising:
rear adapters configured for removable rigid connection of the carriage to the indexer for articulation of the carriage in unison with the indexer;
parallel horizontal spaced-apart guide rails extending across the front of the rear adapters;
at least one jaw fixed on one end of said horizontal spaced-apart guide rails, said at least one jaw adapted to grip an end of a first pipe to be fused;
at least one other jaw slidable on another end of said horizontal spaced-apart guide rails, said at least one other jaw adapted to grip an end of a second pipe to be fused to the first pipe,
said at least another jaw being driven for relative reciprocal movement of the gripped end of the second pipe toward and away from the gripped end of the first pipe during a pipe fusion process.

20. The indexer according to claim 19, horizontal location of one of said pipe end facer and said pipe heater being independently alignable during said relative reciprocal movement of the gripped end of the second pipe for rotation into alignment between the pipes gripped by said at least one jaw and said at least one other jaw.

21. A jaw for gripping a pipe comprising:
an upper half jaw with a semi-cylindrical inner surface;
lower left and right quarter jaws each with an inner surface of radius equal to a radius of said semi-cylindrical inner surface; and
left and right links, each said link being pivotally engaged at an upper end thereof to a corresponding lower portion of said upper half jaw and pivotally engageable at a lower end thereof with a corresponding quarter jaw;
whereby said upper jaw inner surface and said corresponding lower quarter jaw inner surfaces cooperate to conform to the outer surface of a pipe having an outer surface of radius equal to said half jaw radius as the pipe is being gripped thereby.

22. The pipe fusion machine according to claim 21, each of said jaws further comprising an actuator co-operable with a respective said link for selectively manipulating said quarter jaw between open and closed positions.

23. The pipe fusion machine according to claim 21, each of said jaws further comprising:
an upper half jaw insert having an outer radius equal to said radius of said semi-cylindrical inner surface and an inner radius less than said inner radius of said semi-cylindrical inner surface; and
replacement lower left and right quarter jaws each with an inner surface of radius equal to an inner radius of said upper half jaw insert;
whereby said inner surface of said upper jaw insert and corresponding said inner surfaces of said replacement lower quarter jaws cooperate to conform to the outer surface of a pipe having an outer surface of radius less than said radius of the pipe being gripped.

24. The pipe fusion machine according to claim 21, each of said jaws further comprising an actuator co-operable with a respective said link for selectively manipulating said quarter jaw between open and closed positions.

25. The pipe fusion machine according to claim 21, each of said jaws further comprising:
an upper half jaw insert having an outer radius equal to said radius of said semi-cylindrical inner surface and an inner radius less than said inner radius said semi-cylindrical inner surface; and,
replacement lower left and right quarter jaws each with an inner surface of radius equal to an inner radius of said upper half jaw insert;
whereby said inner surface of said upper jaw insert and said inner surfaces of corresponding said lower quarter jaw replacements cooperate to conform to the outer surface of a pipe having an outer surface of radius less than said radius of the pipe being gripped.

26. A machine for fusing polyolefin pipe that includes a hydraulic generator, comprising:
a heater adapted for fusing two opposing ends of polyolefin pipe;
a hydraulic generator motor adapted to actuate a generator;
a supply of hydraulic fluid;
a hydraulic pump adapted to receive said supply of hydraulic fluid at a first flow and distribute said supply of hydraulic fluid at a second flow;
a generator valve adapted to receive said hydraulic fluid at said second flow and meter said fluid at a hydraulic fluid flow sufficient to run said hydraulic generator motor at a constant desired speed;
a generator adapted to be actuated by said hydraulic generator motor in order to produce sufficient electric energy to maintain said heater at least at a temperature sufficient to fuse said two opposing ends of said polyolefin pipe.

27. The machine of claim 26 wherein said hydraulic pump is driven by a motor.

28. The machine of claim 27 wherein said motor powers a power take off (PTO) and said hydraulic pump is driven by said PTO of said motor.

29. The machine of claim 28 wherein said hydraulic pump is mounted to said PTO of said motor.

30. The machine of claim 27 wherein said motor is adapted to run at variable speeds; and,
said hydraulic generator motor adapted to run at said constant desired speed to actuate said generator in order to produce sufficient electric energy to maintain said heater at least at a temperature sufficient to fuse said two opposing ends of said polyolefin pipe regardless of the speed of said motor.

31. The machine of claim 27 wherein said motor, said hydraulic pump, said generator valve, said hydraulic generator motor, and said generator are mounted to a vehicle.

32. The machine of claim 26 wherein said generator is in direct electrical communication with said heater.

33. A method to provide constant electrical energy from a hydraulic generator to maintain a polyolefin pipe fusion heater at least at a temperature sufficient to fuse two opposing ends of polyolefin pipe from a hydraulic system on a machine having multiple hydraulic systems powered by a single engine having an output and a PTO, the method comprising the steps:
providing a supply of hydraulic fluid;
mounting a hydraulic pump to the PTO of the engine;
adapting said hydraulic pump to receive said supply of hydraulic fluid at a first flow and distribute said supply of hydraulic fluid at a second flow;
adapting a generator valve to receive said hydraulic fluid at said second flow and meter said fluid at a hydraulic fluid flow sufficient to run said hydraulic generator motor at a constant desired speed;
mounting said hydraulic generator motor to a generator;
adapting said generator to be actuated by said hydraulic generator motor;
actuating said generator in order to produce sufficient electric energy to maintain the heater at least at a temperature sufficient to fuse two opposing ends of polyolefin pipe.
